(19) United States
(12) Patent Application Publication
(10) Pub. No.: US 2012/0320980 A1
(43) Pub. Date: Dec. 20, 2012

(54) VIDEO DECODING APPARATUS, VIDEO CODING APPARATUS, VIDEO DECODING METHOD, VIDEO CODING METHOD, AND STORAGE MEDIUM

(75) Inventors: Satoshi SHIMADA, Kawasaki (JP); Akira Nakagawa, Sagamihara (JP); Kimihiko Kazui, Kawasaki (JP); Junpei Koyama, Shibuya (JP)

(73) Assignee: FUJITSU LIMITED, Kawasaki-shi (JP)

(21) Appl. No.: 13/472,197

(22) Filed: May 15, 2012

(30) Foreign Application Priority Data
Jun. 15, 2011 (JP) 2011-133384

(51) Int. Cl. H04N 7/32

(52) U.S. Cl. 375/240.16; 375/E07.115; 375/E07.104; 375/E07.243

(57) ABSTRACT

A video decoding apparatus includes a motion vector information storing unit configured to store motion vectors of blocks in previously-decoded pictures and a temporally-adjacent vector predictor generating unit. The temporally-adjacent vector predictor generating unit includes a block determining unit configured to determine multiple blocks in a picture that is temporally adjacent to a picture including a target block to be processed, the determined blocks including a block that is closest to first coordinates in the target block; a vector selecting unit configured to obtain motion vectors of the determined blocks from the motion vector information storing unit and select at least one motion vector from the obtained motion vectors; and a generating unit configured to generate a vector predictor candidate, which is used for a decoding process of the target block, based on the selected motion vector.

### CROSS-REFERENCE TO RELATED APPLICATION

This application is based upon and claims the benefit of priority of Japanese Patent Application No. 2011-133384 filed on Jun. 15, 2011, the entire contents of which are incorporated herein by reference.

### FIELD

The embodiments discussed herein are related to a video decoding apparatus, a video coding apparatus, a video decoding method, a video coding method, and a storage medium.

### BACKGROUND

In recent video coding techniques, a picture is divided into blocks, pixels in the blocks are predicted, and predicted differences are encoded to achieve a high compression ratio. A prediction mode where pixels are predicted from neighboring pixels in a picture to be encoded is called an intra prediction mode. Meanwhile, a prediction mode where pixels are predicted from a previously-encoded reference picture using a motion compensation technique is called an inter prediction mode.

In the inter prediction mode of a video coding apparatus, a reference region used to predict pixels is represented by two-dimensional coordinate data called a motion vector that includes a horizontal component and a vertical component, and motion vector data and difference pixel data between original pixels and predicted pixels are encoded. To reduce the amount of code, a vector predictor is generated based on a motion vector of a block that is adjacent to a target block to be encoded (may be referred to as an encoding target block), and a difference vector between a motion vector of the target block and the vector predictor is encoded. By assigning a smaller amount of code to a smaller difference vector, it is possible to reduce the amount of code for the motion vector and to improve the coding efficiency.

Meanwhile, in a video decoding apparatus, a vector predictor that is the same as the vector predictor generated in the video coding apparatus is determined for each block, and the motion vector is restored by adding the encoded difference vector and the vector predictor. For this reason, the video coding apparatus and the video decoding apparatus include vector prediction units having substantially the same configuration.

In the video decoding apparatus, blocks are decoded, generally, from the upper left to the lower right in the order of the raster scan technique or the z scan technique. Therefore, only a motion vector of a block that is to the left or above a target block to be decoded at the video decoding apparatus, i.e., a motion vector that is decoded before the target block, can be used for prediction by the motion vector prediction units of the video coding apparatus and the video decoding apparatus.

Meanwhile, in MPEG (Moving Picture Experts Group)-4 AVC/H.264 (hereafter may be simply referred to as H.264), a vector predictor may be determined using a motion vector of a previously encoded/decoded reference picture instead of a motion vector of a target picture to be processed (see, for example, ISO/IEC 14496-10 (MPEG-4 Part 10)/ITU-T Rec. H.264).

Also, a method of determining a vector predictor is disclosed in “WD3: Working Draft 3 of High-Efficiency Video Coding” JCTVC-E603, JCT-VC 5th Meeting, March 2011. High-Efficiency Video Coding (HEVC) is a video coding technology the standardization of which is being jointly discussed by ISO/IEC and ITU-T. HEVC Test Model (HM) software (version 3.0) has been proposed as reference software.

The outline of HEVC is described below. In HEVC, reference picture lists L0 and L1 listing reference pictures are provided. For each block, regions of up to two reference pictures, i.e., motion vectors corresponding to the reference picture lists L0 and L1, can be used for inter prediction.

The reference picture lists L0 and L1 correspond, generally, to directions of display time. The reference picture list L0 lists previous pictures with respect to a target picture to be processed, and the reference picture list L1 lists future pictures. Each entry of the reference picture lists L0 and L1 includes a storage location of pixel data and a picture order count (POC) of the corresponding picture.

POCs are represented by integers, and indicate the order in which pictures are displayed and relative display time of the pictures. Assuming that a picture with a POC “0” is displayed at display time “0”, the display time of a given picture can be obtained by multiplying the POC of the picture by a constant. For example, when “fr” indicates the display cycle (Hz) of frames and “p” indicates the POC of a picture, the display time of the picture may be represented by formula (1) below.

Display time=p×(fr/2) formula (1)

Accordingly, it can be said that the POC indicates display time of a picture in units of a constant.

When a reference picture list includes two or more entries, reference pictures that motion vectors refer to are specified by index numbers (reference indexes) in the reference picture list. When a reference picture list includes only one entry (or one picture), the reference index of a motion vector corresponding to the reference picture list is automatically set at “0”. In this case, there is no need to explicitly specify the reference index.

A motion vector of a block includes an L0/L1 list identifier, a reference index, and vector data (Vx, Vy). A reference picture is identified by the L0/L1 list identifier and the reference index, and a region (reference region) in the reference picture is identified by the vector data (Vx, Vy). Vx and Vy in the vector data indicate, respectively, differences between the coordinates of a reference region in the horizontal and vertical axes and the coordinates of a target block (or current block) to be processed. For example, Vx and Vy may be represented in units of quarter pixels. The L0/L1 list identifier and the reference index may be collectively called a reference picture identifier.

A method of determining a vector predictor in HEVC is described below. A vector predictor is determined for each reference picture identified by the L0/L1 list identifier and the reference index. In determining vector data mvp of a vector predictor for a motion vector referring to a reference picture identified by a list identifier LX and a reference index refidx, up to three sets of vector data are calculated as vector predictor candidates.

Blocks that are spatially and temporally adjacent to a target block are categorized into three groups: blocks to the left of the target block (left group), blocks above the target block (upper group), and blocks temporally adjacent to the target block (temporally-adjacent group). From each of the three groups, up to one vector predictor candidate is selected.

Selected vector predictor candidates are listed in the order of priority of the groups: the temporally-adjacent group, the left group, and the upper group. This list is placed in an array mvp_cand. If no vector predictor candidate is present in all the groups, a 0 vector is added to the array mvp_cand.

A predictor candidate index mvp_idx is used to identify one of the vector predictor candidates in the list which is to be used as the vector predictor. That is, the vector data of a vector predictor candidate located at the “mvp_idx”-th position in the array mvp_cand are used as the vector data mvp of the vector predictor.

When my indicates a motion vector of an encoding target block which refers to a reference picture identified by the list identifier LX and the reference index refidx, the video coding apparatus searches the array mvp_cand to find a vector predictor candidate closest to the motion vector mv, and sets the index of the found vector predictor candidate as the predictor candidate index mvp_idx. Also, the video coding apparatus calculates a difference vector mvd using formula (2) below and encodes refidx, mvd, and mvp_idex as motion vector information for the list LX.

mvd=my−mvp formula (2)

The video decoding apparatus decodes refidx, mvd, and mvp_idex, determines mvp_cand based on refidx, and uses the vector predictor candidate located at the “mvp_idx”-th position in mvp_cand as the vector predictor mvp. The video decoding apparatus restores the motion vector my of the target block based on formula (3) below.

mv=mvd+mvp formula (3)

Next, blocks spatially adjacent to a target block are described. FIG. 1 is a drawing illustrating blocks spatially adjacent to a target block. With reference to FIG. 1, an exemplary process of selecting vector predictor candidates from blocks to the left of the target block and blocks above the target block is described.

In HEVC and H.264, the size (minimum block size) of a minimum block used in motion compensation is predetermined. All other block sizes are obtained by multiplying the minimum block size by a power of two. Assuming that the minimum block size is represented by MINX and MINY, n indicates an integer greater than or equal to 0 (n≧0), and m indicates an integer greater than or equal to 0 (m≧0), the horizontal and vertical sizes of a block are expressed by the following formulas:

Horizontal size: MINX×2ⁿ

Vertical size: MINY×2^{m}

In HEVC and H.264, MINX is set at four pixels and MINY is set at four pixels. In other words, a block can be divided into minimum blocks. In FIG. 1, A0, A1, and B0 through B2 indicate minimum blocks adjacent to the target block. When a minimum block is specified, a block including the minimum block can be uniquely identified.

Next, an exemplary process of selecting a vector predictor candidate from the blocks to the left of the target block is described. If a motion vector 1, which is a motion vector of a block including the lower-left minimum block A0 and has the list identifier LX and the reference index refidx, is found, the motion vector 1 is selected.

If the motion vector 1 is not found, a motion vector 2, which is a motion vector of a block including the minimum block A1 and has the list identifier LX and the reference index refidx, is searched for. If the motion vector 2 is found, the motion vector 2 is selected.

If the motion vector 2 is not found, a motion vector 3, which refers to a reference picture that is in a reference picture list LY and is the same as the reference picture indicated by the reference index refidx of the reference picture list LX, is searched for in the block including the minimum block A0. If the motion vector 3 is found, the motion vector 3 is selected.

If the motion vector 3 is not found, any motion vector found in the block including the minimum block A0 is selected. If no motion vector is found in the block including the minimum block A0, a motion vector is searched for in the block including the minimum block A1 in a similar manner.

If the motion vector selected in the above process does not refer to a reference picture that is the same as the reference picture indicated by the reference index refidx of the reference picture list LX, a scaling process described later is performed.

Next, an exemplary process of selecting a vector predictor candidate from the blocks above the target block is described. A motion vector is searched for in blocks including minimum blocks B0, B1, and B2 above the target block in this order in a manner similar to that for the blocks including the minimum blocks A0 and A1. If the motion vector selected in this process does not refer to a reference picture that is the same as the reference picture indicated by the reference index refidx of the reference picture list LX, a scaling process described later is performed.

Next, blocks temporally adjacent to a target block are described. FIG. 2 is a drawing used to describe a process of selecting a vector predictor candidate from a block temporally adjacent to a target block.

First, a temporally-adjacent reference picture 20, which includes a temporally-adjacent block and is called a collocated picture (ColPic), is selected. The ColPic 20 is a reference picture with reference index “0” in the reference picture list L0 or L1. Normally, a ColPic is a reference picture with reference index “0” in the reference picture list L1.

An mvCol 22, which is a motion vector of a block (Col block) 21 located in the ColPic 20 at the same position as a target block 11, is scaled by a scaling method described later to generate a vector predictor candidate.

An exemplary positional relationship between the target block 11 and the Col block 21 is described below. FIG. 3 is a drawing illustrating an exemplary positional relationship between the target block 11 and the Col block 21. In the ColPic 20, a block including a minimum block TR or a minimum block TC is determined as the Col block 21. The minimum block TR is given priority over the minimum block TC. If the intra prediction mode is used for the block including the minimum block TR or if the block is located outside of the screen, the block including the minimum block TC is determined as the Col block 21. In this example, the minimum block TR having priority is adjacent to the lower right corner of the target block 11 and is shifted from the target block 11.

Next, an exemplary method of scaling a motion vector is described. Here, it is assumed that an input motion vector is represented by mv=(mvx, mvy), an output vector (vector predictor candidate) is represented by mv′=(mvx′, mvy′), and my is mvCol.

Also, ColRefPic 23 indicates a picture that my refers to, ColPicPoc indicates the POC of the picture 20 including mv, ColRefPoc indicates the POC of the ColRefPic 23, CurrPoc indicates the POC of a current target picture 10, and CurrRefPoc indicates the POC of a picture 25 identified by RefPicList_LX and RefIdx.

When the motion vector to be scaled is a motion vector of a spatially-adjacent block, ColPicPoc equals CurrPoc. When the motion vector to be scaled is a motion vector of a temporally-adjacent block, ColPicPoc equals the POC of ColPic.

As indicated by formulas (4) and (5) below, my is scaled based on the ratio between time intervals of pictures.

mvx′=mvx×(CurrPoc−CurrRefPoc)/(ColPicPoc−ColRefPoc) formula (4)

mvy′=mvy×(CurrPoc−CurrRefPoc)/(ColPicPoc−ColRefPoc) formula (5)

However, since division requires a large amount of calculation, my′ may be approximated, for example, by multiplication and shift using formulas below.

DiffPocD=ColPicPoc−ColRefPoc formula (6)

DiffPocB=CurrPoc−CurrRefPoc formula (7)

TDB=Clip3(−128,127,DiffPocB) formula (8)

TDD=Clip3(−128,127,DiffPocD) formula (9)

iX=(0×4000+abs(TDD/2))/TDD formula (10)

Scale=Clip3(−1024,1023,(TDB×iX+32)>>6) formula (11)

abs( ): a function that returns an absolute value

Clip3(x, y, z): a function that returns a median of x, y, and z

>>: right arithmetic shift

“Scale” obtained by formula (11) is used as a scaling factor. In this example, Scale=256 indicates a coefficient of “1”, i.e., my is not scaled.

Based on the scaling factor Scale, scaling calculations are performed using the formulas below.

mvx′=(Scale×mvx+128)>>8 formula (12)

mvy′=(Scale×mvy+128)>>8 formula (13)

Since a block can be divided into minimum blocks, motion vectors may be stored for the respective minimum blocks of a previously-processed block. When the next block is processed, the motion vectors of minimum blocks are used to generate a spatially-adjacent vector predictor and a temporally-adjacent vector predictor.

With motion vectors stored for respective minimum blocks, it is possible to access a motion vector of a spatially or temporally adjacent block by simply specifying the address of a minimum block.

Here, storing motion vectors for respective minimum blocks increases the amount of motion vector information for one picture. “CE9: Reduced resolution storage of motion vector data, JCTVC-D072, 2011-01 Daegu” discloses a technology where the amount of motion vector information is reduced after processing of one picture is completed to prevent this problem.

When N indicates an integer 2ⁿ (a power of two), one minimum block in each group of N×N minimum blocks in the horizontal and vertical directions is selected as a representative block, and only the motion vector information of the representative block is stored.

FIG. 4 is a drawing illustrating exemplary representative blocks. In this example, N is set at 4, and the upper-left minimum block (block 0, 16) in each group of 4×4 minimum blocks is selected as the representative block.

When the amount of the motion vector information is reduced as described above, only the motion vectors of representative blocks can be used to generate temporally-adjacent vector predictor candidates.

### SUMMARY

According to an aspect of this disclosure, there is provided a video decoding apparatus that includes a motion vector information storing unit configured to store motion vectors of blocks in previously-decoded pictures and a temporally-adjacent vector predictor generating unit. The temporally-adjacent vector predictor generating unit includes a block determining unit configured to determine multiple blocks in a picture that is temporally adjacent to a picture including a target block to be processed, the determined blocks including a block that is closest to first coordinates in the target block; a vector selecting unit configured to obtain motion vectors of the determined blocks from the motion vector information storing unit and select at least one motion vector from the obtained motion vectors; and a generating unit configured to generate a vector predictor candidate, which is used for a decoding process of the target block, based on the selected motion vector.

The object and advantages of the invention will be realized and attained by means of the elements and combinations particularly pointed out in the claims.

It is to be understood that both the foregoing general description and the followed detailed description are exemplary and explanatory and are not restrictive of the invention as claimed.

### BRIEF DESCRIPTION OF DRAWINGS

FIG. 1 is a drawing illustrating blocks spatially adjacent to a target block;

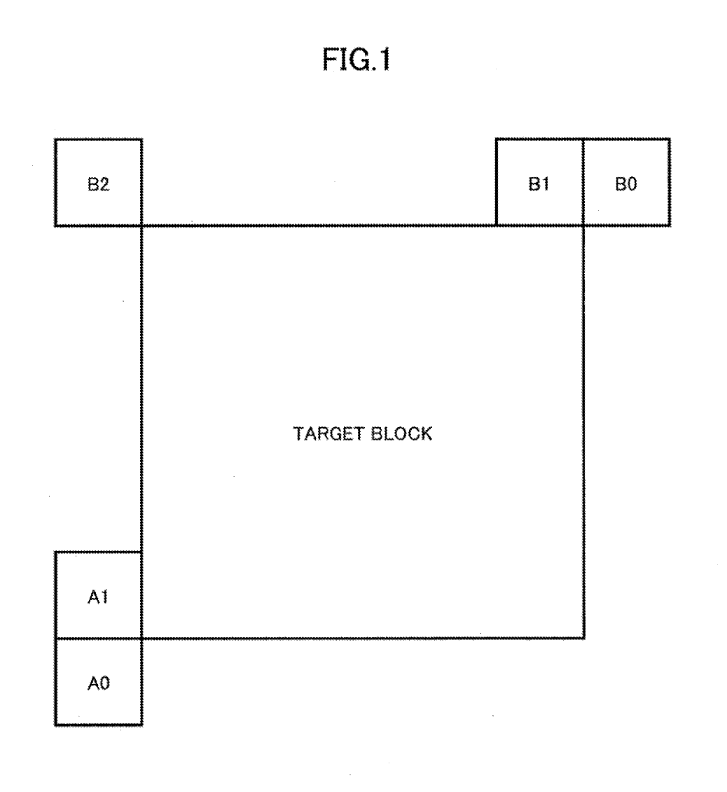

FIG. 2 is a drawing used to describe a process of selecting a vector predictor candidate from a block temporally adjacent to a target block;

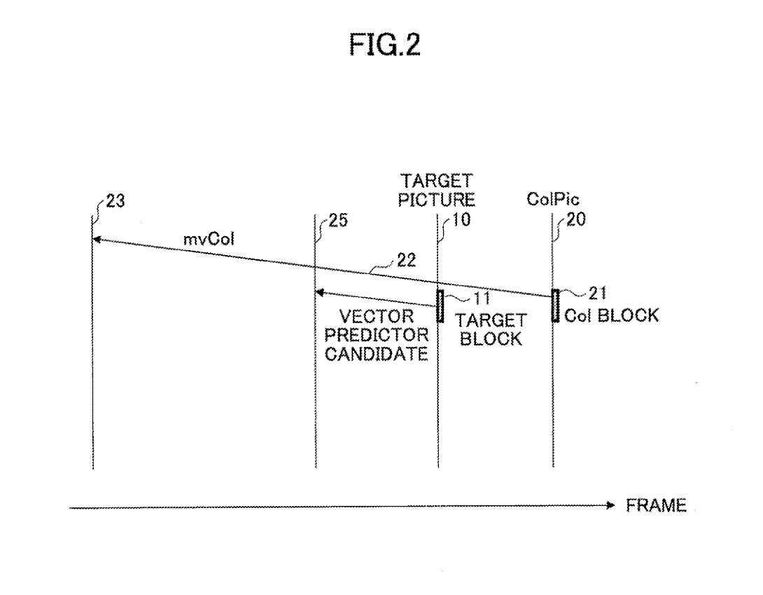

FIG. 3 is a drawing illustrating an exemplary positional relationship between a target block and a Col block;

FIG. 4 is a drawing illustrating exemplary representative blocks;

FIG. 5 is a drawing used to describe a problem in the related art;

FIG. 6 is a block diagram illustrating an exemplary configuration of a video decoding apparatus according to a first embodiment;

FIG. 7 is a block diagram illustrating an exemplary configuration of a vector predictor generating unit according to the first embodiment;

FIG. 8 is a block diagram illustrating an exemplary configuration of a temporally-adjacent vector predictor generating unit according to the first embodiment;

FIG. 9 is a drawing illustrating exemplary positions of blocks determined by a block determining unit according to the first embodiment;

FIG. 10 is a block diagram illustrating an exemplary configuration of a vector selection unit according to the first embodiment;

FIG. 11 is a drawing illustrating a first example of a positional relationship among first through third coordinates;

FIG. 12 is a drawing illustrating a second example of a positional relationship among first through third coordinates;

FIG. 13 is a drawing used to describe an advantageous effect of the first embodiment;

FIG. 14 is a flowchart illustrating an exemplary process performed by a video decoding apparatus of the first embodiment;

FIG. 15 is a flowchart illustrating an exemplary process performed by a temporally-adjacent vector predictor generating unit of the first embodiment;

FIG. 16 is a drawing used to describe a problem in the related art;

FIG. 17 is another drawing used to describe a problem in the related art;

FIG. 18 is a block diagram illustrating exemplary configurations of a motion vector information storing unit and a temporally-adjacent vector predictor generating unit according to a second embodiment;

FIG. 19 is a drawing illustrating an example of determined representative blocks according to the second embodiment;

FIG. 20 is a drawing illustrating another example of determined representative blocks according to the second embodiment;

FIG. 21 is a block diagram illustrating an exemplary configuration of a temporally-adjacent vector predictor generating unit according to a third embodiment;

FIG. 22 is a drawing illustrating an example of determined representative blocks according to the third embodiment;

FIG. 23 is a block diagram illustrating an exemplary configuration of a video coding apparatus according to a fourth embodiment;

FIG. 24 is a flowchart illustrating an exemplary process performed by a video coding apparatus of the fourth embodiment; and

FIG. 25 is a drawing illustrating an exemplary configuration of an image processing apparatus.

### DESCRIPTION OF EMBODIMENTS

In HEVC, when movement in a screen is random and big to some extent, the accuracy of a temporal vector predictor candidate generated based on a motion vector of a temporally-adjacent block may become low.

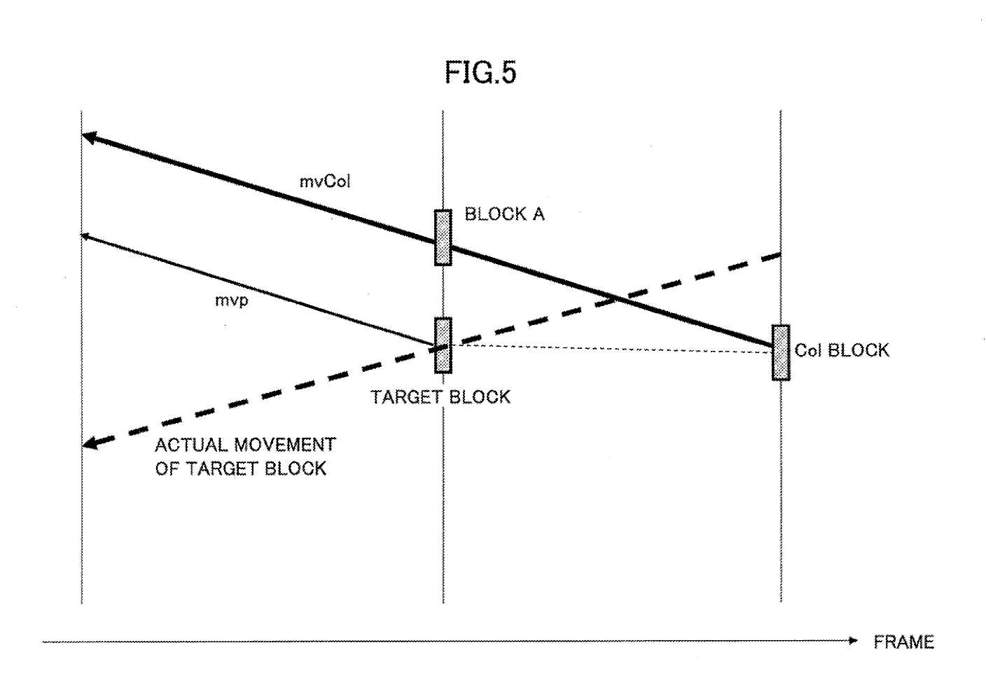

FIG. 5 is a drawing used to describe a problem in the related art. Assuming that objects on a screen move at a constant speed, movement of an object in a Col block is represented by mvCol. In this case, a vector predictor mvp of a motion vector of a target block is obtained by scaling mvCol.

As illustrated in FIG. 5, when mvCol is large, mvCol intersects with a block A that is apart from the target block. In other words, the object included in the Col block is in the block A on the target picture. Here, as the distance between the target block and the block A increases, the possibility that the actual movement of the target block differs from the movement of the block A increases, and the accuracy of the vector predictor candidate may become lower.

An aspect of this disclosure makes it possible to improve the accuracy of a temporal vector predictor candidate.

Preferred embodiments of the present invention are described below with reference to the accompanying drawings.

### First Embodiment

### Configuration

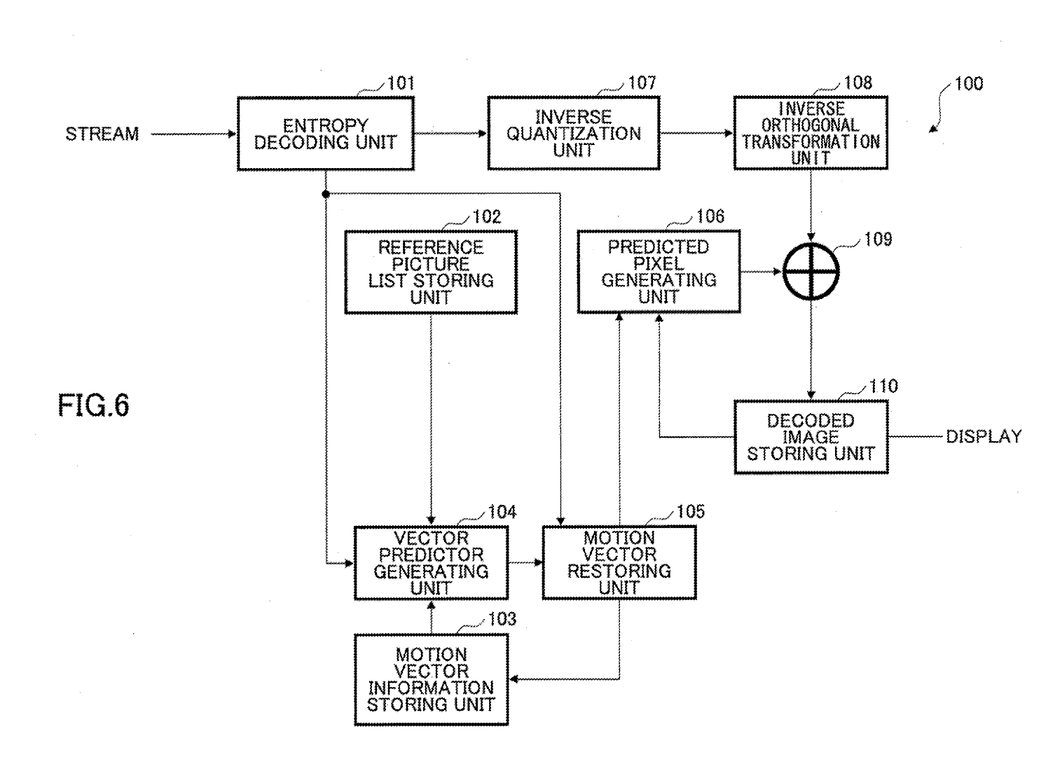

FIG. 6 is a block diagram illustrating an exemplary configuration of a video decoding apparatus 100 according to a first embodiment. As illustrated in FIG. 6, the video decoding apparatus 100 may include an entropy decoding unit 101, a reference picture list storing unit 102, a motion vector information storing unit 103, a vector predictor generating unit 104, a motion vector restoring unit 105, a predicted pixel generating unit 106, an inverse quantization unit 107, an inverse orthogonal transformation unit 108, a decoded pixel generating unit 109, and a decoded image storing unit 110.

The entropy decoding unit 101 performs entropy decoding on a compressed stream, and thereby decodes reference indexes, difference vectors, and predictor candidate indexes for L0 and L1 of a target block, and an orthogonal transformation coefficient.

The reference picture list storing unit 102 stores picture information including POCs of reference pictures that a target block can refer to, and storage locations of image data.

The motion vector information storing unit 103 stores motion vectors of blocks in previously-decoded pictures. For example, the motion vector information storing unit 103 stores motion vector information including motion vectors of blocks that are temporally and spatially adjacent to a target block and reference picture identifiers indicating pictures that the motion vectors refer to. The motion vector information is generated by the motion vector restoring unit 105.

The vector predictor generating unit 104 obtains the reference indexes (reference picture identifiers) of L0 and L1 from the entropy decoding unit 101, and generates lists of vector predictor candidates for a motion vector of the target block. Details of the vector predictor generating unit 104 are described later.

The motion vector restoring unit 105 obtains the predictor candidate indexes and the difference vectors for L0 and L1 from the entropy decoding unit 101, and adds vector predictor candidates indicated by the predictor candidate indexes to the corresponding difference vectors to restore motion vectors.

The predicted pixel generating unit 106 generates a predicted pixel signal using the restored motion vectors and a decoded image stored in the decoded image storing unit 110.

The inverse quantization unit 107 performs inverse quantization on the orthogonal transformation coefficient obtained from the entropy decoding unit 101. The inverse orthogonal transformation unit 108 generates a prediction error signal by performing inverse orthogonal transformation on an inversely-quantized signal output from the inverse quantization unit 107. The prediction error signal is output to the decoded pixel generating unit 109.

The decoded pixel generating unit 109 adds the predicted pixel signal and the prediction error signal to generate decoded pixels.

The decoded image storing unit 110 stores a decoded image including the decoded pixels generated by the decoded pixel generating unit 109. The decoded image stored in the decoded image storing unit 110 is output to a display unit.

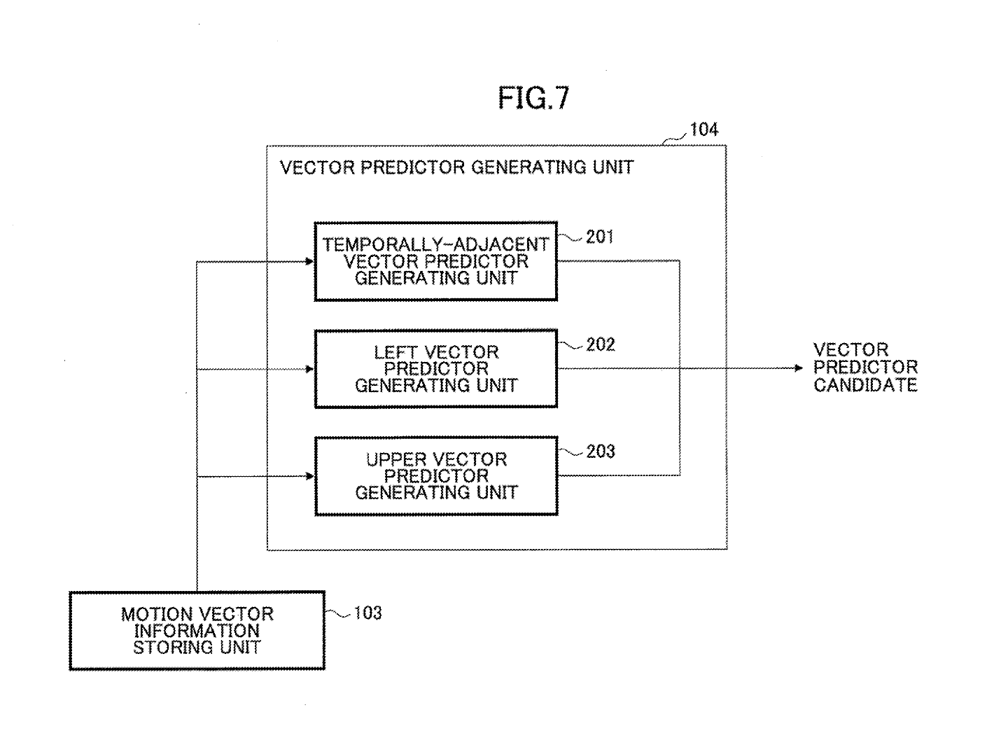

Next, the vector predictor generating unit 104 is described in more detail. FIG. 7 is a block diagram illustrating an exemplary configuration of the vector predictor generating unit 104 according to the first embodiment. As illustrated in FIG. 7, the vector predictor generating unit 104 may include a temporally-adjacent vector predictor generating unit 201, a left vector predictor generating unit 202, and an upper vector predictor generating unit 203.

The vector predictor generating unit 104 receives a reference picture identifier of a target block and POC information of a target picture. Here, LX indicates a reference list identifier and refidx indicates a reference index for the target block.

The motion vector information storing unit 103 stores motion vector information for respective minimum blocks of each previously-processed block. The same motion vector information is stored for the minimum blocks in the same block. The motion vector information includes an identifier of a picture to which a minimum block belongs, an identifier of a prediction mode, an identifier of a picture that the motion vector refers to, and values of horizontal and vertical components of the motion vector.

A block can be uniquely identified by specifying a minimum block included in the block. Therefore, specifying a minimum block is substantially equivalent to specifying a block. In the descriptions below, a block adjacent to a target block is specified by specifying a minimum block.

The left vector predictor generating unit 202 generates a vector predictor candidate based on a motion vector of a block (left-adjacent block) to the left of a target block. A related-art method may be used to generate a vector predictor candidate based on a motion vector of a left-adjacent block.

The upper vector predictor generating unit 203 generates a vector predictor candidate based on a motion vector of a block (upper-adjacent block) above a target block. A related-art method may be used to generate a vector predictor candidate based on a motion vector of an upper-adjacent block.

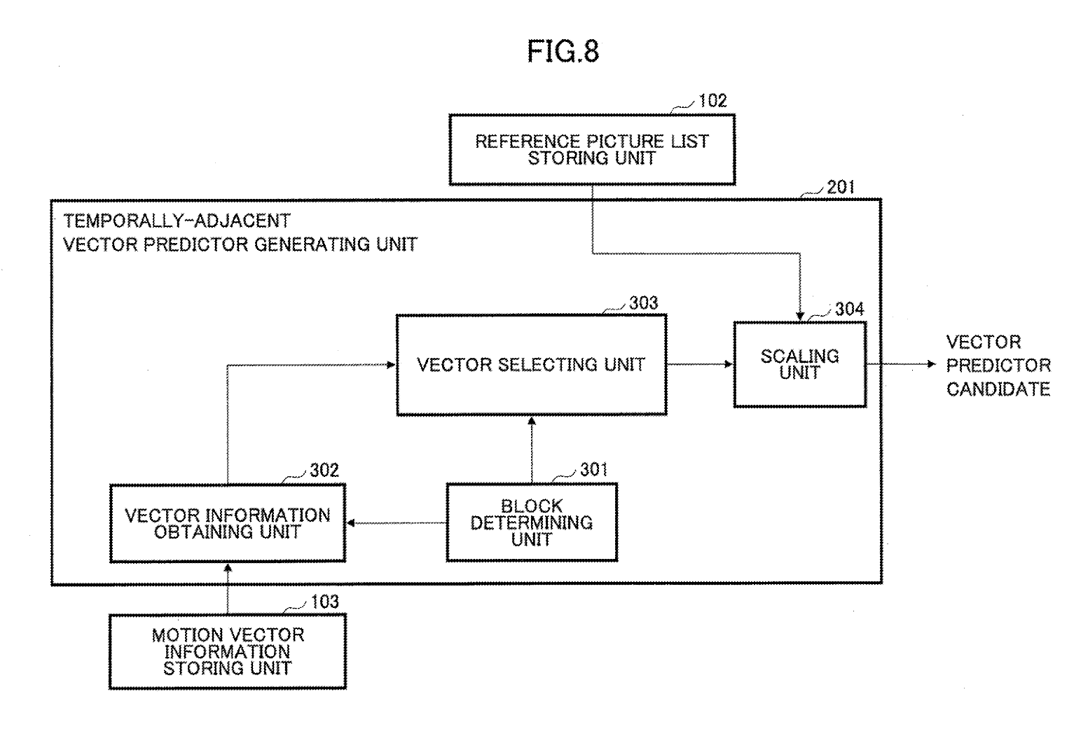

The temporally-adjacent vector predictor generating unit 201 generates a vector predictor candidate based on a motion vector of a block (temporally-adjacent block) that is temporally adjacent to a target block. Details of the temporally-adjacent vector predictor generating unit 201 are described with reference to FIG. 8.

FIG. 8 is a block diagram illustrating an exemplary configuration of the temporally-adjacent vector predictor generating unit 201 according to the first embodiment. As illustrated in FIG. 8, the temporally-adjacent vector predictor generating unit 201 may include a block determining unit 301, a vector information obtaining unit 302, a vector selecting unit 303, and a scaling unit 304.

The block determining unit 301 obtains positional information of a target block and determines a minimum block C that is a center block in the target block. The minimum block C includes a center position (x1, y1) of the target block.

When the upper-left coordinates of the target block are represented by (x0, y0) in units of pixels and N and M indicate the horizontal size and the vertical size of the target block in units of pixels, first coordinates are represented by formulas (14) and (15) below.

x1=x0+(N/2) formula (14)

y1=y0+(M/2) formula (15)

The first coordinates may be shifted to the lower right. For example, when MINX and MINY indicate the horizontal size and the vertical size of the minimum block, the first coordinates may be represented by formulas (16) and (17) below.

x1=x0+(N/2)+(MINX/2) formula (16)

y1=y0+(M/2)+(MINY/2) formula (17)

When the center position (x1, y1) is at a boundary between minimum blocks, the block determining unit 301 determines a minimum block that is to the lower right of the center position (x1, y1) as the minimum block C. The block determining unit 301 determines multiple blocks including a block closest to the first coordinates (e.g., the center coordinates of the target block) in a previously-processed, temporally-adjacent picture.

For example, the block determining unit 301 determines a minimum block C′ that is at the same position as the minimum block C and minimum blocks 1 through 4 that are apart from the minimum block C′ by a predetermined distance.

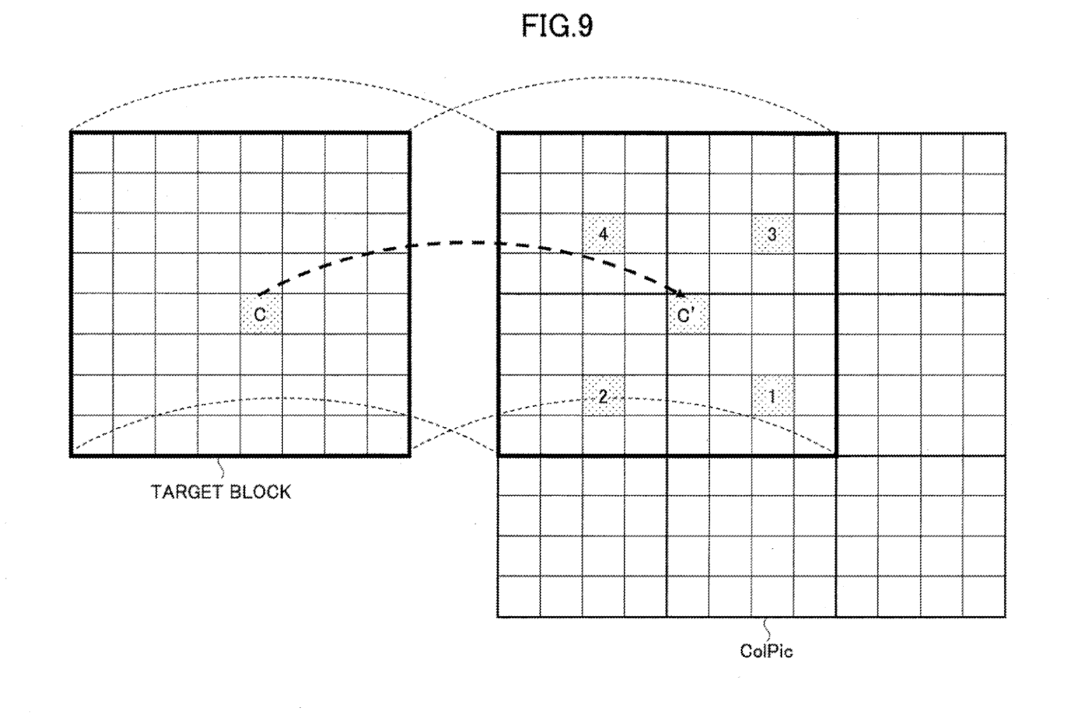

FIG. 9 is a drawing illustrating exemplary positions of blocks determined by the block determining unit 301. As illustrated in FIG. 9, the block determining unit 301 determines a minimum block C that is the center block in the target block, and determines a minimum block C′ that is in ColPic and at the same position as the minimum block C. Also, the block determining unit 301 determines minimum blocks 1 through 4 that are apart from the minimum block C′ by a predetermined distance.

Referring back to FIG. 8, the block determining unit 301 outputs positional information of the determined blocks to the vector information obtaining unit 302 and the vector selecting unit 303.

The vector information obtaining unit 302 obtains motion vector information of the blocks determined by the block determining unit 301. The motion vector information of each block includes a motion vector, an identifier of a picture to which the block including the motion vector belongs, and a reference picture identifier of a reference picture that the motion vector refers to. The vector information obtaining unit 302 outputs the obtained motion vector information to the vector selecting unit 303.

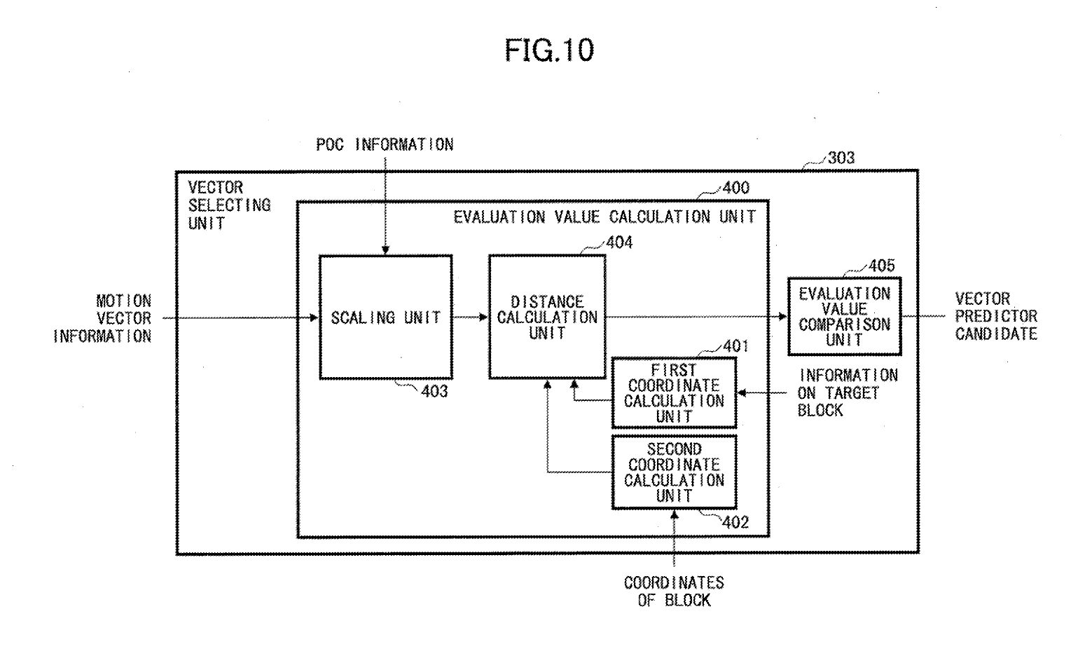

The vector selecting unit 303 selects at least one of the motion vectors included in the blocks determined by the block determining unit 301. Details of the vector selecting unit 303 are described later with reference to FIG. 10. The vector selecting unit 303 outputs the selected motion vector(s) to the scaling unit 304.

The scaling unit 304 scales the selected motion vector by using formulas (4) and (5) or formulas (12) and (13) described above. The scaled motion vector is used as a temporal vector predictor candidate.

FIG. 10 is a block diagram illustrating an exemplary configuration of the vector selecting unit 303 according to the first embodiment. As illustrated in FIG. 10, the vector selecting unit 303 may include an evaluation value calculation unit 400 and an evaluation value comparison unit 405. The evaluation value calculation unit 400 may include a first coordinate calculation unit 401, a second coordinate calculation unit 402, a scaling unit 403, and a distance calculation unit 404.

The first coordinate calculation unit 401 obtains information on a target block and calculates first coordinates in the target block. Here, the upper-left coordinates of the target block are represented by (x0, y0) in units of pixels, and N and M indicate the horizontal size and the vertical size of the target block in units of pixels.

Assuming that the center coordinates of the target block are the first coordinates (x1, y1), the first coordinate calculation unit 401, similarly to the block determining unit 301, calculates the first coordinates using formulas (14) and (15).

Alternatively, the first coordinate calculation unit 401 may calculate the first coordinates shifted to the lower right by using formulas (16) and (17). The first coordinates may be in a lower-right region of the target block which includes the center coordinates of the target block.

Generally, since spatial vector predictor candidates are obtained based on motion vectors of blocks to the left and above the target block, the accuracy of spatial vector predictor candidates in the left and upper regions of the target block is high.

Therefore, shifting the center coordinates (the first coordinates) to the lower right makes it possible to improve the accuracy of vector predictor candidates in a lower-right region where the accuracy of spatial vector predictor candidates is low. The first coordinate calculation unit 401 outputs the calculated first coordinates to the distance calculation unit 404.

Here, each of the minimum blocks determined by the block determining unit 301 and to be evaluated by the evaluation value calculation unit 400 is referred to as a block T (or an evaluation target minimum block). The evaluation value calculation unit 400 first evaluates the minimum block C determined by the block determining unit 301 as the block T, and evaluates each of the minimum blocks 1 through 4 in sequence as the block T. However, if the intra prediction mode is used for a block and the block includes no motion vector, the block is not evaluated and the next block is evaluated.

The second coordinate calculation unit 402 calculates the coordinates (second coordinates) of the block T that is determined by the block determining unit 301 and temporally adjacent to the target block. Here, the second coordinates are represented by (x2, y2) and the upper-left coordinates of the block T are represented by (x′0, y′0).

The second coordinate calculation unit 402 calculates the second coordinates using formulas (18) and (19) below.

x2=x′0 formula (18)

y2=y′0 formula (19)

Alternatively, when MINX and MINY indicate the horizontal size and the vertical size of a minimum block, the second coordinate calculation unit 402 may calculate the center coordinates of the minimum block as the second coordinates using formulas (20) and (21) below.

x2=x′0+MINX/2 formula (20)

y2=y′0+MINY/2 formula (21)

The second coordinate calculation unit 402 outputs the calculated second coordinates to the distance calculation unit 404.

The scaling unit 403 calculates a second motion vector by scaling a first motion vector, which is the motion vector of the block T, such that the second motion vector refers to the target picture from ColPic.

When CurrPoc indicates the POC of the target picture, ColPicPoc indicates the POC of ColPic, ColRefPoc indicates the POC of a picture that the motion vector of the block T refers to, and (mvcx, mvcy) indicates the horizontal and vertical components of the first motion vector of the block T, the second motion vector (mvcx′, mvcy′) is calculated using formulas (22) and (23) below.

mvcx′=mvcx×(CurrPoc−ColPicPoc)/(ColRefPoc−ColPicPoc) formula (22)

mvcy′=mvcy×(CurrPoc−ColPicPoc)/(ColRefPoc−ColPicPoc) formula (23)

Alternatively, the scaling unit 403 may scale the first motion vector to obtain the second motion vector by multiplication and shift as indicated in formulas (12) and (13).

The distance calculation unit 404 adds the second coordinates (x2, y2) and the second motion vector (mvcx′, mvcy′) to obtain third coordinates (x3, y3) as indicated by formulas (24) and (25) below.

x3=x2+mvcx′ formula (24)

y3=y2+mvcy′ formula (25)

In other words, the distance calculation unit 404 calculates the coordinates of an intersection between the target picture and the second motion vector as the third coordinates (x3, y3).

Then, the distance calculation unit 404 calculates a distance (evaluation value) D between the first coordinates (x1, y1) and the third coordinates (x3, y3) using formula (26) below.

D=abs(x1−x3)+abs(y1−y3) formula (26)

abs ( ): a function that returns an absolute value

Instead of using formula (26), the evaluation value D may also be obtained using a formula including other evaluation components.

When the first coordinates are obtained using formulas (16) and (17) and the second coordinates are obtained using formulas (20) and (21), the result of formula (26) does not change even if MINX/2 and MINY/2 are removed from formulas (16), (17), (20), and (21). Accordingly, the result obtained using formulas (14), (15), (18), and (19) is the same as the result obtained using formulas (16), (17), (20), and (21).

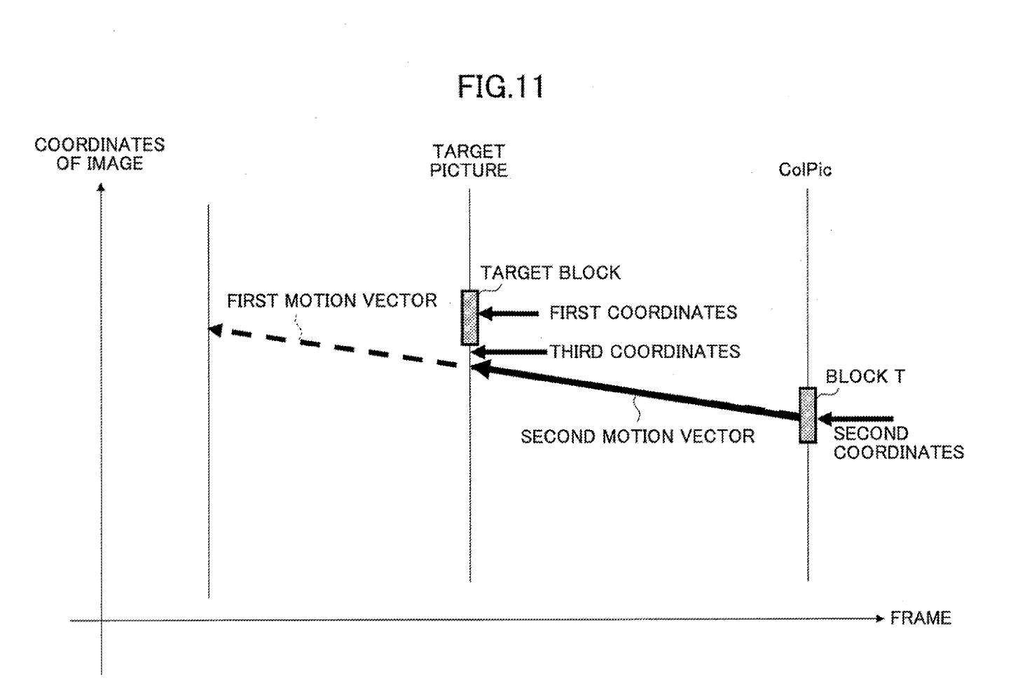

Positional relationships among the first through third coordinates are described below. FIG. 11 is a drawing illustrating a first example of a positional relationship among the first through third coordinates. In the example of FIG. 11, the first motion vector intersects with the target picture.

The scaling unit 403 scales the first motion vector to generate the second motion vector. The distance calculation unit 404 adds the second coordinates of the block T and the second motion vector to obtain the third coordinates. Then, the distance calculation unit 404 calculates the distance D between the first coordinates of the target block and the third coordinates. The distance D is used to select a motion vector to be used as a vector predictor candidate.

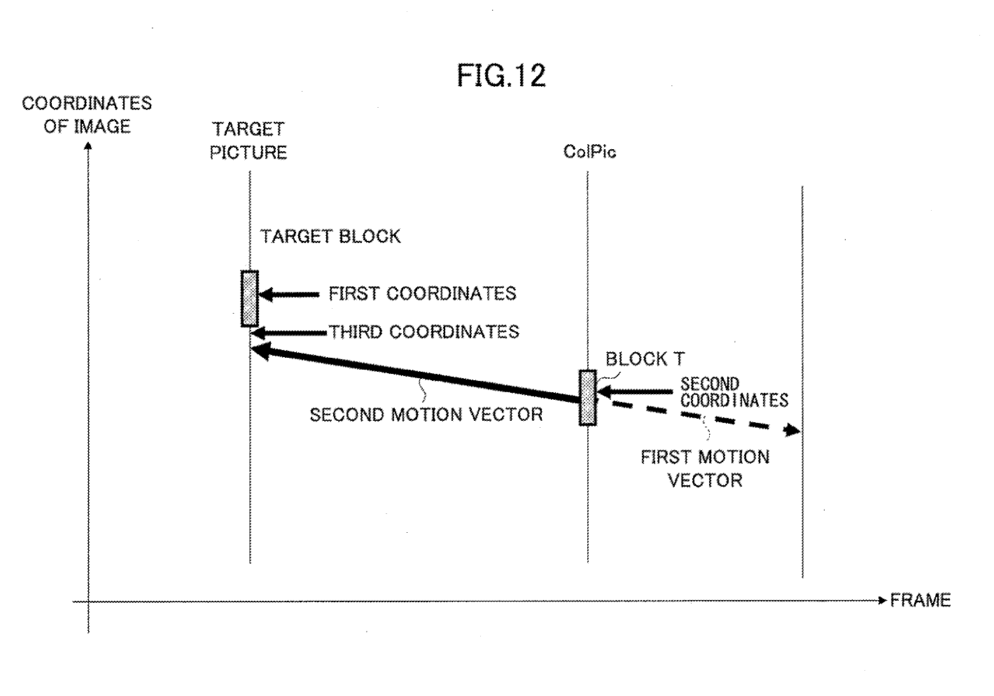

FIG. 12 is a drawing illustrating a second example of a positional relationship among the first through third coordinates. In the example of FIG. 12, the first motion vector does not intersect with the target picture. Also in this example, the distance D between the first coordinates and the third coordinates is calculated and used to select a motion vector to be used as a vector predictor candidate.

Referring back to FIG. 10, the evaluation value calculation unit 400 repeats the above calculations until evaluation values are calculated for all the evaluation target minimum blocks, i.e., the blocks T. The distance D is an example of the evaluation value. The evaluation value calculation unit 400 outputs the evaluation values (the distances D) to the evaluation value comparison unit 405.

The evaluation value comparison unit 405 receives the motion vector information and the evaluation values of the evaluation target minimum blocks from the evaluation value calculation unit 400 and retains the received motion vector information and evaluation values. When receiving the motion vector information and the evaluation value of the last one of the evaluation target minimum blocks, the evaluation value comparison unit 405 selects a motion vector with the smallest evaluation value as a vector predictor candidate.

Instead of comparing the evaluation values of all the evaluation target minimum blocks with each other, the evaluation value comparison unit 405 may be configured to compare the evaluation values (the distances D) of the evaluation target minimum blocks with a predetermined threshold in the order received. In this case, if an evaluation target minimum block with an evaluation value (a distance D) less than or equal to the threshold is found, the evaluation value comparison unit 405 selects the motion vector of the found evaluation target minimum block and stops the comparison process.

For example, when the block size of the target block is “N×M”, the evaluation value comparison unit 405 may set the threshold at “N+M”.

Also, the evaluation value comparison unit 405 may stop the comparison process when an evaluation target minimum block that satisfies abs(x1−x3)<N and abs(y1−y3)<M is found.

The motion vector output from the evaluation value comparison unit 405 is scaled by the scaling unit 304.

Thus, the above configuration makes it possible to select a motion vector that passes through the target block as a temporal vector predictor candidate based on the distance between the first coordinates and the third coordinates, and thereby makes it possible to improve the prediction accuracy of the temporal vector predictor candidate.

In the first embodiment, five evaluation target minimum blocks are determined by the block determining unit 301. However, more than five or less than five evaluation target minimum blocks may be determined by the block determining unit 301.

Each of the evaluation target minimum blocks may include two motion vectors: an L0 vector and an L1 vector. The vector selecting unit 303 may be configured to select one of the L0 and L1 vectors for evaluation. For example, when ColRefPic indicates a picture that a motion vector to be evaluated refers to, the vector selecting unit 303 may be configured to select a motion vector such that the target picture is sandwiched between ColRefPic and ColPic.

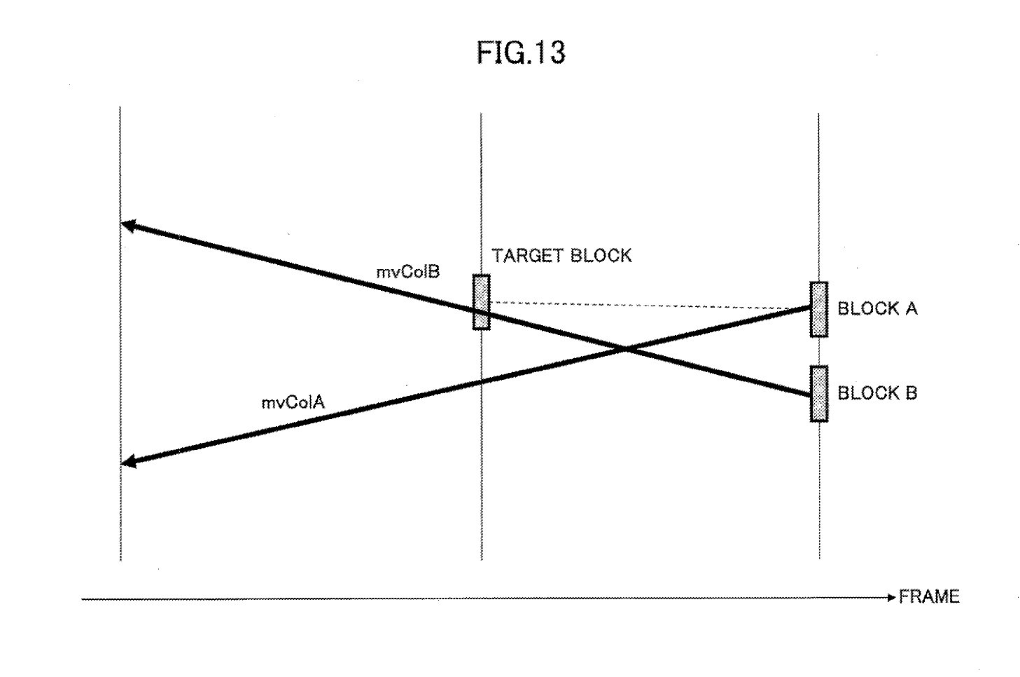

FIG. 13 is a drawing used to describe an advantageous effect of the first embodiment. When there are two candidate blocks A and B as illustrated in FIG. 13 and the block A is the Col block, according to the related art, mvColA is selected as a vector predictor candidate. Meanwhile, according to the first embodiment, mvColB with a smaller evaluation value (distance D) is selected. Thus, the first embodiment makes it possible to improve the accuracy of a temporal vector predictor candidate.

### <Operations>

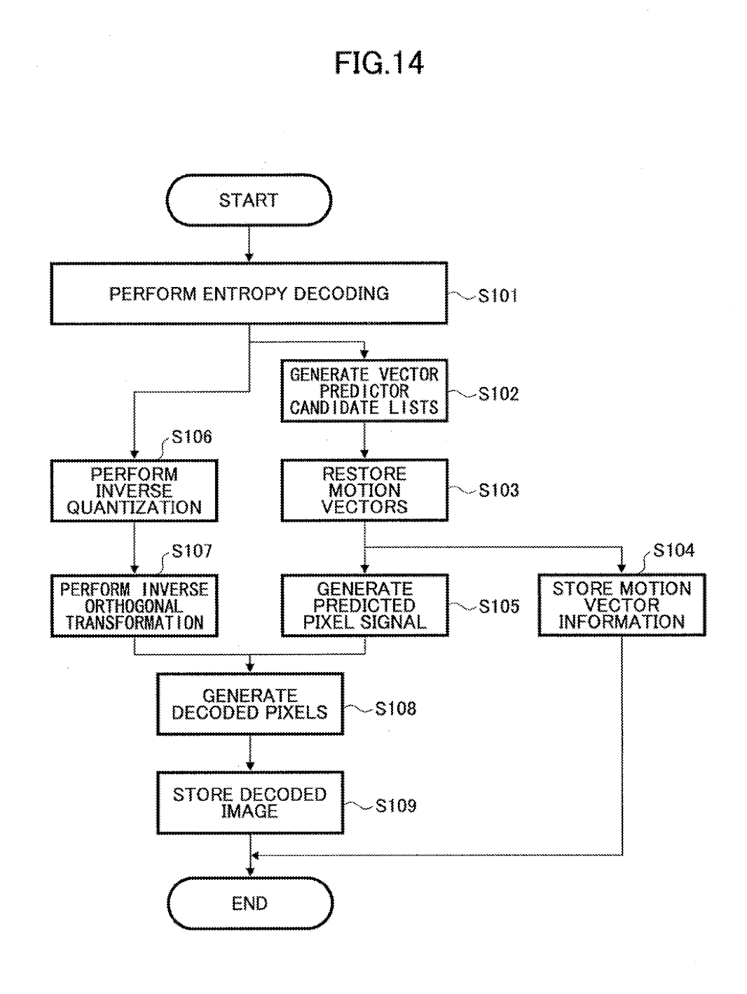

Next, exemplary operations of the video decoding apparatus 100 of the first embodiment are described. FIG. 14 is a flowchart illustrating an exemplary process performed by the video decoding apparatus 100 of the first embodiment. In the process of FIG. 14, one block, which is a unit of processing, is decoded.

In step S101, the entropy decoding unit 101 performs entropy decoding on input stream data, and thereby decodes a reference index, a difference vector, and a predictor candidate index for L0 of the target block; a reference index, a difference vector, and a predictor candidate index for L1 of the target block; and an orthogonal transformation coefficient.

In step S102, the vector predictor generating unit 104 generates lists (vector predictor candidate lists) of vector predictor candidates for L0 and L1 based on the decoded reference indexes of L0 and L1 and motion vector information.

In step S103, the motion vector restoring unit 105 obtains the predictor candidate indexes and the difference vectors for L0 and L1 which are decoded by the entropy decoding unit 101. The motion vector restoring unit 105 identifies vector predictors for L0 and L1 from the vector predictor candidate lists based on the predictor candidate indexes. Then, the motion vector restoring unit 105 adds the identified vector predictors and the difference vectors to restore motion vectors of L0 and L1 (L0 and L1 motion vectors).

In step S104, the motion vector restoring unit 105 stores motion vector information including the reference indexes for the restored motion vectors of L0 and L1 in the motion vector information storing unit 103. The stored information is used in the subsequent block decoding process.

In step S105, the predicted pixel generating unit 106 obtains the L0 motion vector and the L1 motion vector, obtains pixel data of regions that the motion vectors refer to from the decoded image storing unit 110, and generates a predicted pixel signal.

In step S106, the inverse quantization unit 107 performs inverse quantization on the orthogonal transformation coefficient decoded by the entropy decoding unit 101.

In step S107, the inverse orthogonal transformation unit 108 generates a prediction error signal by performing inverse orthogonal transformation on the inversely-quantized signal.

Steps S102 through S104 and steps S106 and S107 are not necessarily performed in the order described above, and may be performed in parallel.

In step S108, the decoded pixel generating unit 109 adds the predicted pixel signal and the prediction error signal to generate decoded pixels.

In step S109, the decoded image storing unit 110 stores a decoded image including the decoded pixels. The decoding process of one block is completed through the above steps, and the steps are repeated to decode the next block.

### <Vector Predictor Candidates of Temporally-Adjacent Blocks>

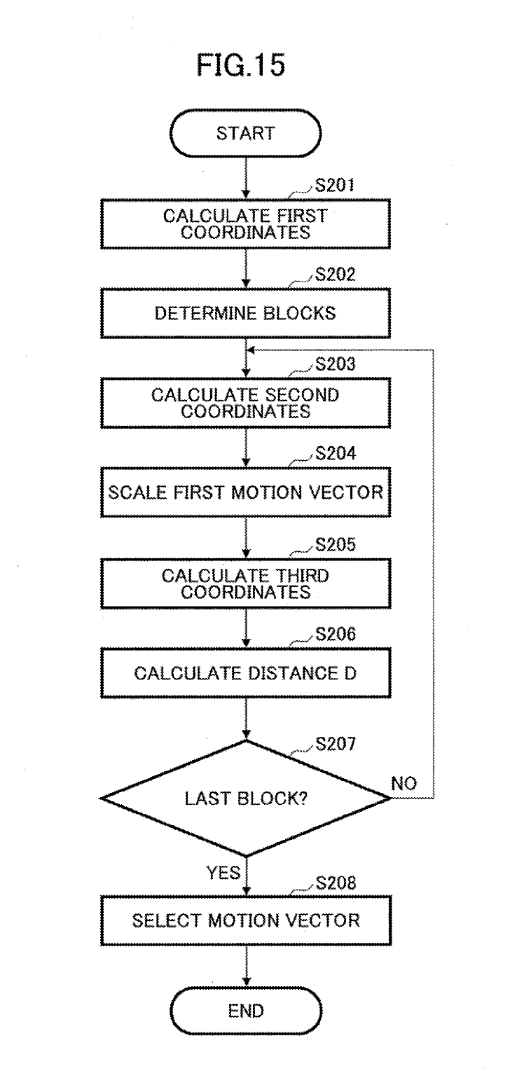

Next, an exemplary process of generating vector predictor candidates of blocks temporally adjacent to the target block is described. FIG. 15 is a flowchart illustrating an exemplary process performed by the temporally-adjacent vector predictor generating unit 201 of the first embodiment.

In step S201 of FIG. 15, the first coordinate calculation unit 401 calculates the first coordinates in the target block. For example, the center coordinates of the target block may be calculated as the first coordinates.

In step S202, the block determining unit 301 determines multiple blocks including a block closest to the center coordinates of the target block, in a picture that is temporally adjacent to the target block. The method of determining the blocks is as described above.

In step S203, the second coordinate calculation unit 402 calculates the second coordinates in one of the blocks determined by the block determining unit 301.

In step S204, the scaling unit 403 generates the second motion vector by scaling the first motion vector of one of the determined blocks such that the second motion vector refers to the target block.

In step S205, the distance calculation unit 404 adds the second motion vector and the second coordinates to obtain the third coordinates.

In step S206, the distance calculation unit 404 calculates the distance D between the first coordinates and the third coordinates. The distance calculation unit 404 outputs information including the calculated distance D to the evaluation value comparison unit 405.

In step S207, the evaluation value comparison unit 405 determines whether information including the distance D is obtained for all the blocks determined by the block determining unit 301. The number of blocks to be determined by the block determining unit 301 may be set beforehand in the evaluation value comparison unit 405.

If the obtained information is for the last one of the determined blocks (YES in step S207), the process proceeds to step S208. Meanwhile, if the obtained information is not for the last one of the determined blocks (NO in step S207), the process returns to step S202 and steps S203 through S206 are repeated for the remaining blocks.

In step S208, the evaluation value comparison unit 405 compares the distances D obtained for the determined blocks, selects the first motion vector corresponding to the smallest distance D, and outputs motion vector information including the selected first motion vector. The selected first motion vector is used as a temporal vector predictor candidate.

Thus, the first embodiment makes it possible to select a motion vector that passes through the target block as a temporal vector predictor candidate based on the distance between the first coordinates and the third coordinates, and thereby makes it possible to improve the prediction accuracy of the temporal vector predictor candidate. Naturally, improving the accuracy of a vector predictor candidate makes it possible to improve the prediction accuracy of a vector predictor.

### Second Embodiment

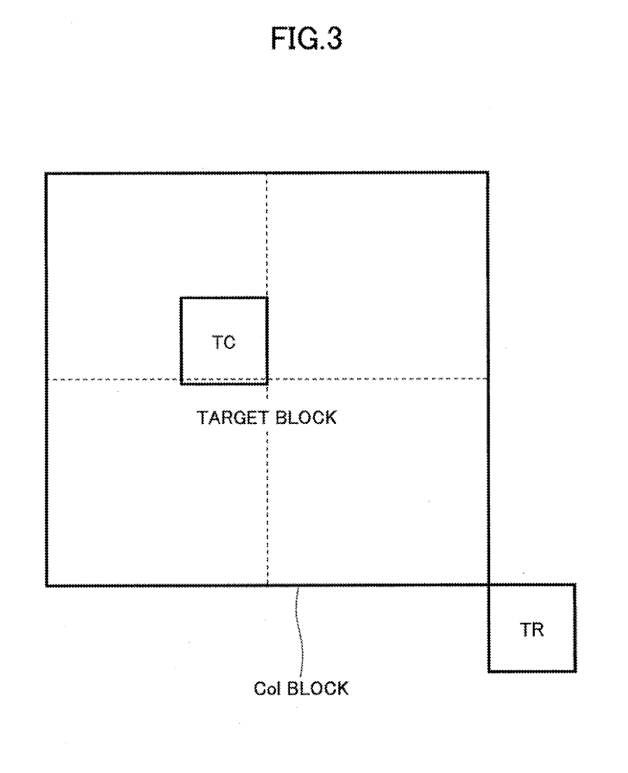

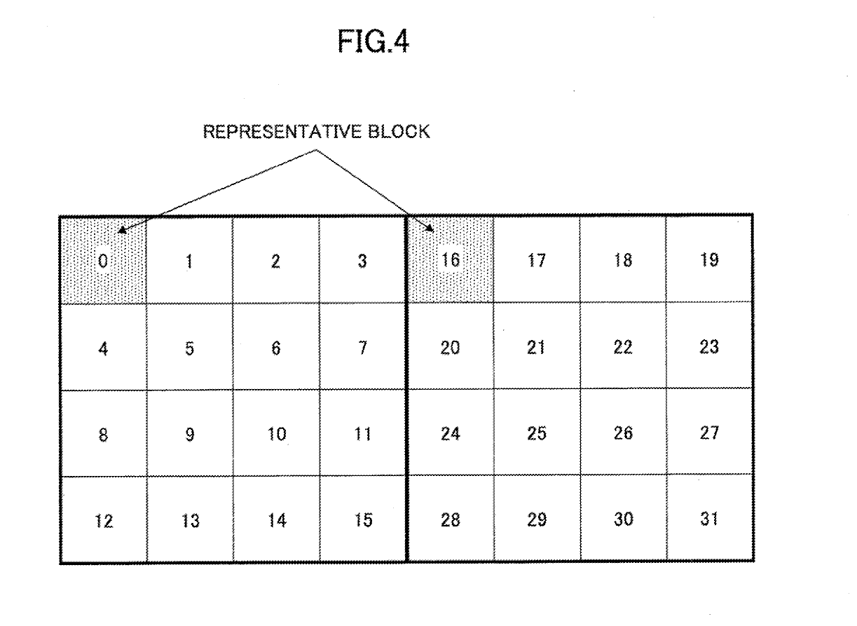

Next, a video decoding apparatus according to a second embodiment is described. The second embodiment makes it possible to improve the prediction accuracy of a temporal vector predictor candidate even if the amount of motion vector information is reduced as described above with reference to FIGS. 3 and 4.

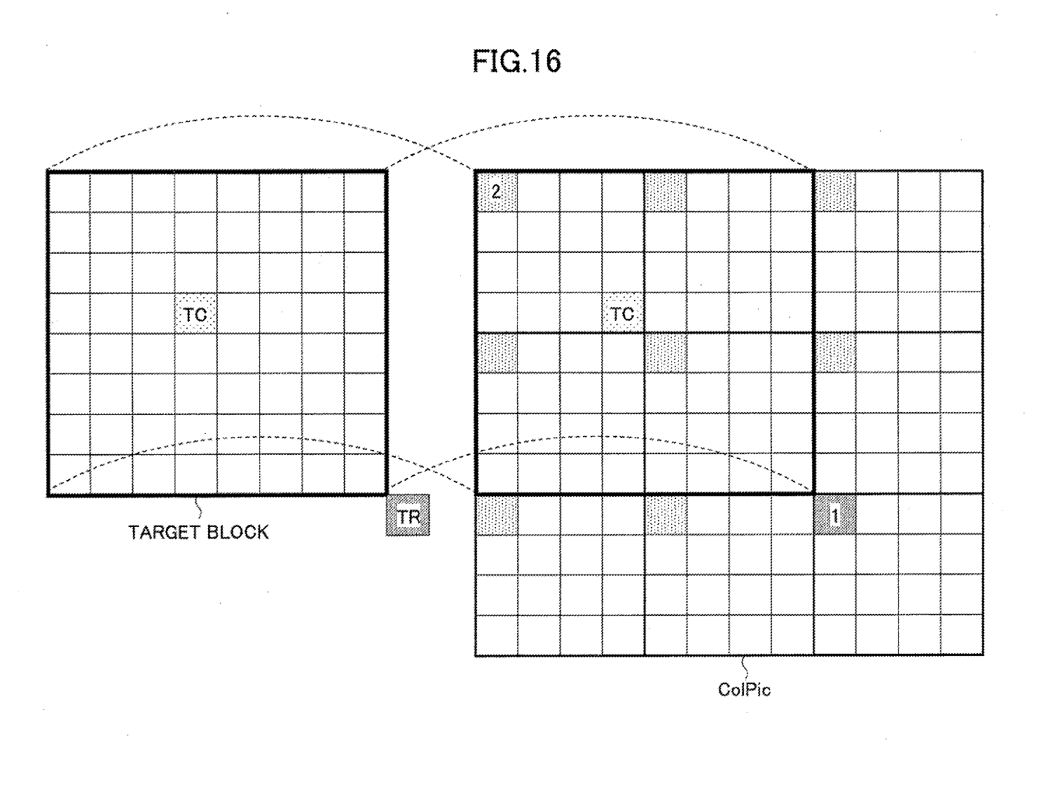

First, problems in HEVC related to a mode for reducing the amount of motion vector information is described. FIG. 16 is a drawing used to describe a problem in the related art. As illustrated in FIG. 16, when TR is determined as the Col block, a motion vector stored for a minimum block 1 is selected. Meanwhile, when TC is determined as the Col block, a motion vector stored for a minimum block 2 is selected.

In this case, if the target block is large, the distance between the position of the Col block and the center position of the target block becomes large regardless of whether the minimum block 1 or the minimum block 2 is determined as the Col block, and as a result, the prediction accuracy of the temporal vector predictor candidate is reduced.

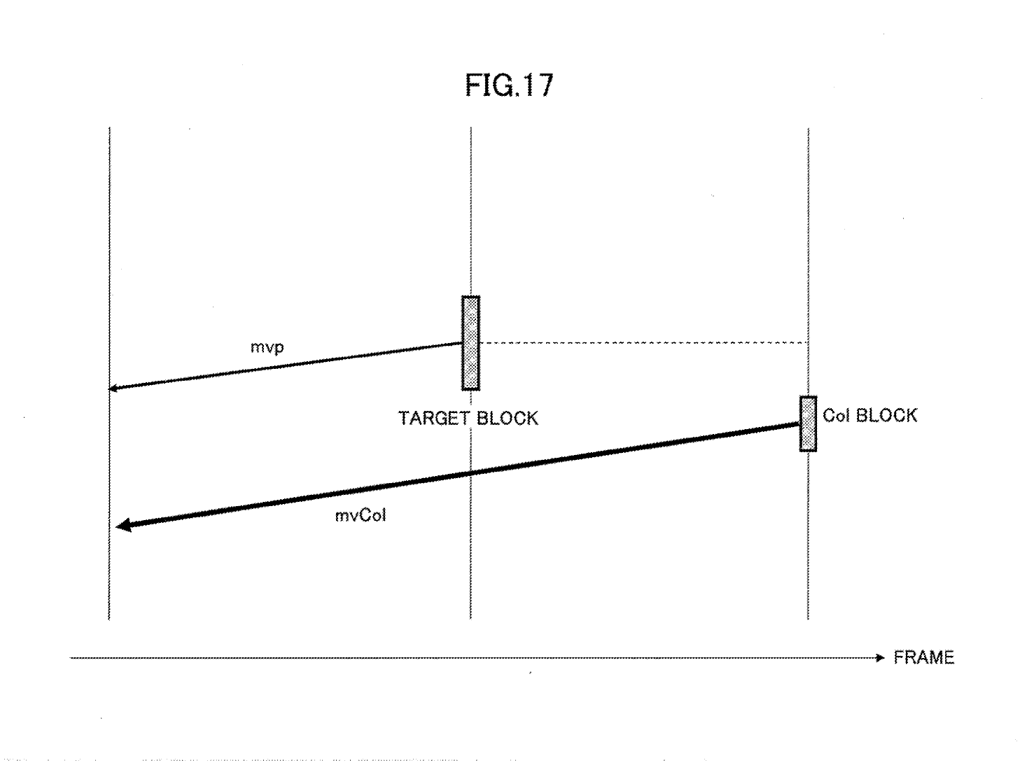

FIG. 17 is another drawing used to describe a problem in the related art. As illustrated in FIG. 17, when a block including TR is determined as the Col block, the Col block becomes apart from the center position of the target block and the prediction accuracy of the motion vector of the Col block becomes low.

The second embodiment makes it possible to improve the prediction accuracy of a temporal vector predictor candidate even when an apparatus or method includes a mode for reducing the amount of motion vector information.

### <Configuration>

Components of a video decoding apparatus of the second embodiment, excluding a motion vector information storing unit 501 and a temporally-adjacent vector predictor generating unit 503, are substantially the same as those of the video decoding apparatus 100 of the first embodiment. Therefore, the motion vector information storing unit 501 and the temporally-adjacent vector predictor generating unit 503 are mainly described below.

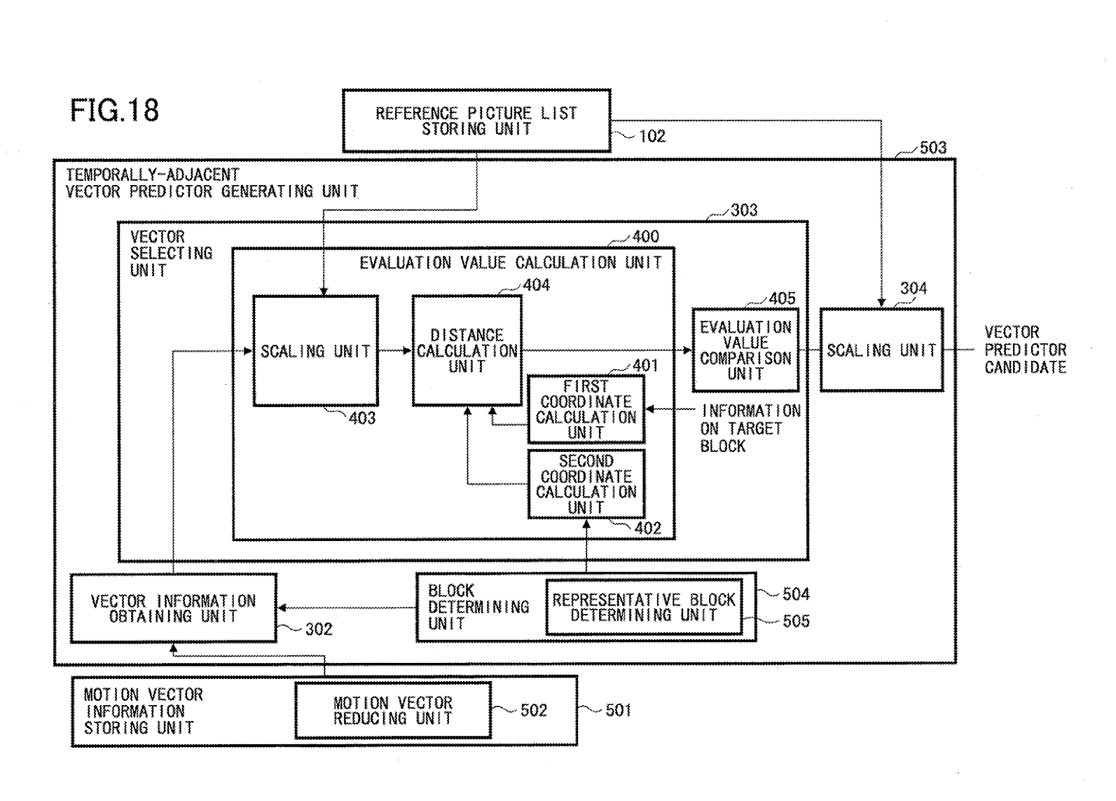

FIG. 18 is a block diagram illustrating exemplary configurations of the motion vector information storing unit 501 and the temporally-adjacent vector predictor generating unit 503 according to the second embodiment. The same reference numbers as in the first embodiment are assigned to the corresponding components in FIG. 18, and descriptions of those components are omitted here.

The motion vector information storing unit 501 includes a motion vector reducing unit 502. The motion vector information storing unit 501 stores motion vectors for respective minimum blocks of each block. When processing of one picture is completed, the motion vector reducing unit 502 reduces the amount of motion vector information.

For example, the motion vector reducing unit 502 determines whether each minimum block is a representative block. If the minimum block is a representative block, the motion vector of the minimum block is retained in the motion vector information storing unit 501. Meanwhile, if the minimum block is not a representative block, the motion vector reducing unit 502 removes the motion vector of the minimum block.

Thus, the motion vector reducing unit 502 determines a representative block in a predetermined range of blocks, and causes the motion vector information storing unit 501 to retain one motion vector (the motion vector of the representative block) for the predetermined range of blocks.

The predetermined range may be defined, for example, as a group of 4×4 minimum blocks in the horizontal and vertical directions. For example, referring to FIG. 4, when the upper-left minimum block in the predetermined range is determined as the representative block, the motion vector information of a minimum block 0 is used as the motion vector information of minimum blocks 1 through 15. Similarly, the motion vector information of a minimum block 16 is used as the motion vector information of minimum blocks 17 through 31.

The temporally-adjacent vector predictor generating unit 503 includes a block determining unit 504. The block determining unit 504 includes a representative block determining unit 505.

The block determining unit 504 determines a minimum block C that is at the center of the target block in a manner similar to the first embodiment. First, the block determining unit 504 calculates first coordinates (x1, y1) in the target block.

Similarly to the first embodiment, the block determining unit 504 calculates the first coordinates using formulas (14) and (15) or formulas (16) and (17). The block determining unit 504 determines a minimum block including the first coordinates (x1, y1) as the minimum block C at the center of the target block. When the first coordinates (x1, y1) are at a boundary between minimum blocks, the block determining unit 504 determines a minimum block that is to the lower right of the first coordinates (x1, y1) as the minimum block C.

The representative block determining unit 505 calculates positions of minimum blocks and determines a predetermined number of representative blocks (in this example, representative blocks 1 through 4) that are closest to the minimum block C.

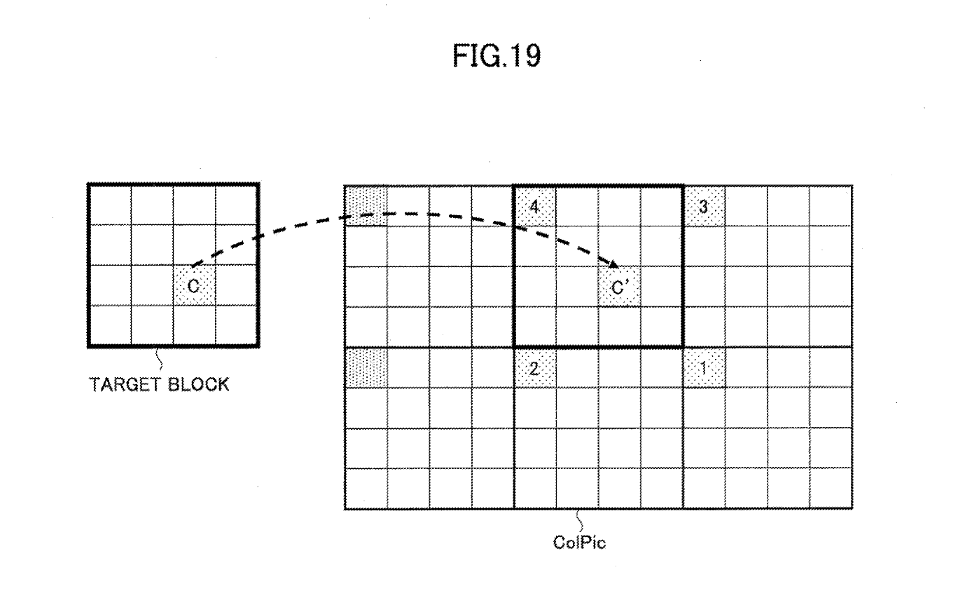

FIG. 19 is a drawing illustrating an example of determined representative blocks according to the second embodiment. In the example of FIG. 19, the minimum block C does not overlap the representative blocks 1 through 4. As illustrated in FIG. 19, the representative block determining unit 505 determines the representative blocks 1 through 4 that are closest to a minimum block C′ located in ColPic at the same position as the minimum block C.

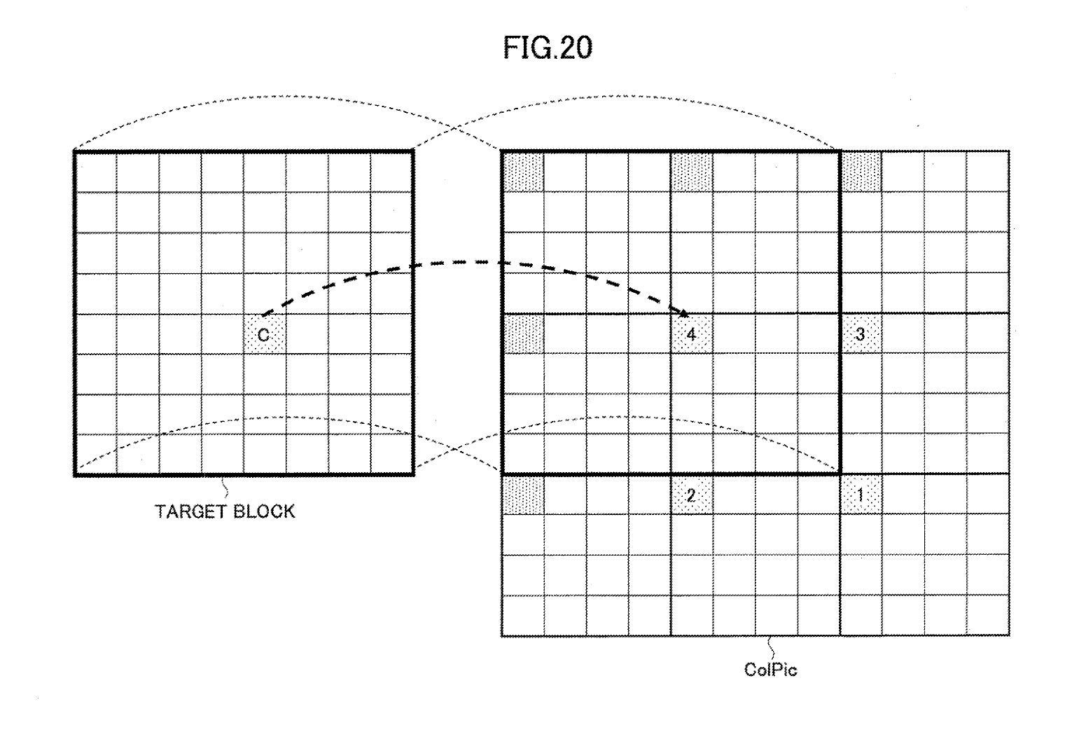

FIG. 20 is a drawing illustrating another example of determined representative blocks according to the second embodiment. In the example of FIG. 20, the minimum block C overlaps one of the representative blocks 1 through 4. As illustrated in FIG. 20, the representative block determining unit 505 determines the representative block 4 that overlaps the minimum block C, and determines the representative blocks 1 through 3 that are close to the representative block 4.

In the second embodiment, four representative blocks are determined by the representative block determining unit 505. However, more than four or less than four representative blocks may be determined by the representative block determining unit 505.

Components other than the motion vector information storing unit 501 and the temporally-adjacent vector predictor generating unit 503 of the video decoding apparatus of the second embodiment are substantially the same as those of the first embodiment, and therefore their descriptions are omitted here.

### <Operations>

Exemplary operations of the video decoding apparatus of the second embodiment are described below. The video decoding apparatus of the second embodiment may perform substantially the same decoding process as that illustrated in FIG. 14, and therefore descriptions of the decoding process are omitted here. The temporally-adjacent vector predictor generating unit 503 of the second embodiment may perform substantially the same process as that performed by the temporally-adjacent vector predictor generating unit 201 of the first embodiment, except that the temporally-adjacent vector predictor generating unit 503 determines representative blocks as described above in step S202 of FIG. 15.

Thus, the second embodiment makes it possible to improve the prediction accuracy of a temporal vector predictor candidate even if the amount of motion vector information is reduced.

### Third Embodiment

Next, a video decoding apparatus according to a third embodiment is described. The third embodiment is a variation of the second embodiment, and also makes it possible to improve the prediction accuracy of a temporal vector predictor candidate even if the amount of motion vector information is reduced as described above with reference to FIGS. 3 and 4.

### <Configuration>

Components of a video decoding apparatus of the third embodiment, excluding a temporally-adjacent vector predictor generating unit 600, are substantially the same as those of the video decoding apparatus of the second embodiment. Therefore, the temporally-adjacent vector predictor generating unit 600 is mainly described below.

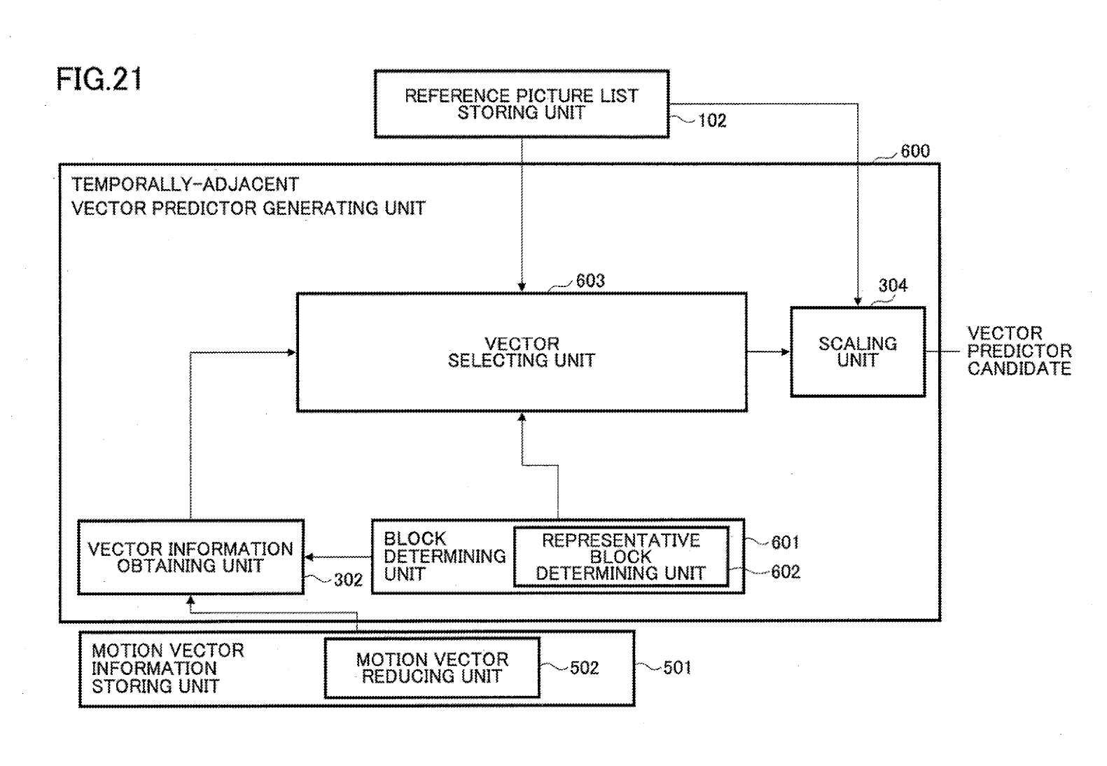

FIG. 21 is a block diagram illustrating an exemplary configuration of the temporally-adjacent vector predictor generating unit 600 according to the third embodiment.

The temporally-adjacent vector predictor generating unit 600 includes a block determining unit 601. The block determining unit 601 includes a representative block determining unit 602.

The block determining unit 601 determines a minimum block C that is at the center of the target block in a manner similar to the first embodiment. First, the block determining unit 601 calculates first coordinates (x1, y1) in the target block.

Similarly to the first embodiment, the block determining unit 601 calculates the first coordinates using formulas (14) and (15) or formulas (16) and (17). The block determining unit 601 determines a minimum block including the first coordinates (x1, y1) as the minimum block C at the center of the target block. When the first coordinates (x1, y1) are at a boundary between minimum blocks, the block determining unit 601 determines a minimum block that is to the lower right of the first coordinates (x1, y1) as the minimum block C.

The representative block determining unit 602 determines a representative block that is closest to the position of the minimum block C as a representative block 1. Next, the representative block determining unit 602 determines representative blocks 2 through 5 that are close to the representative block 1. In the third embodiment, five representative blocks are determined by the representative block determining unit 602. However, more than five or less than five representative blocks may be determined by the representative block determining unit 602.

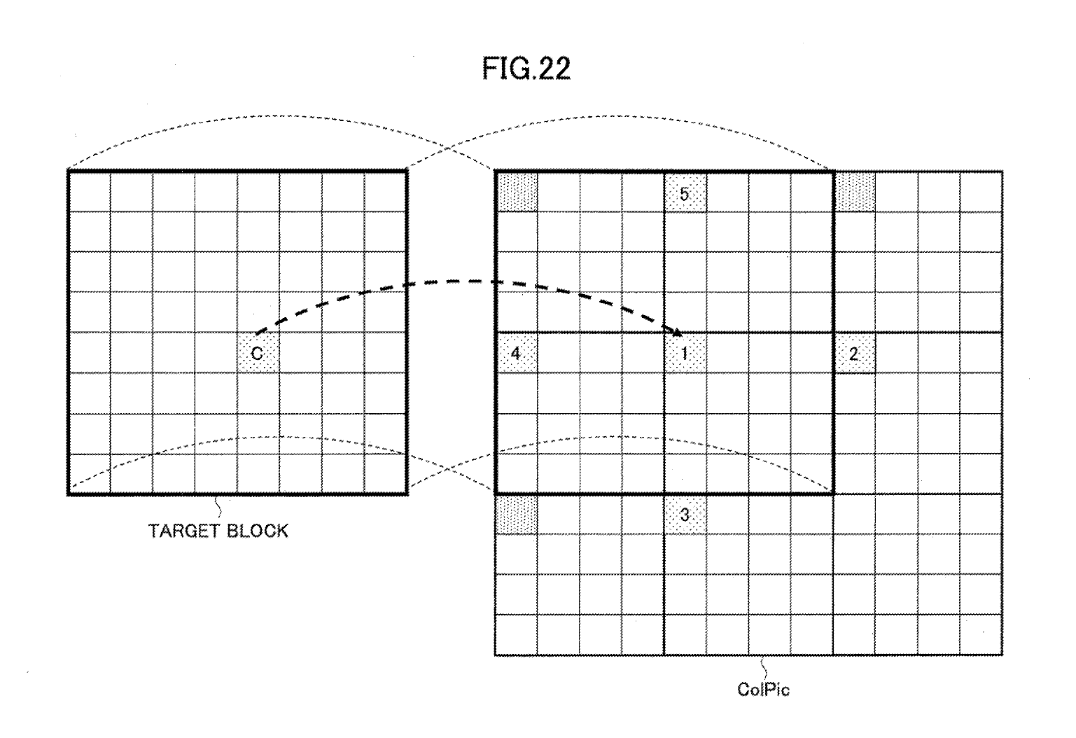

FIG. 22 is a drawing illustrating an example of determined representative blocks according to the third embodiment. In the example of FIG. 22, the representative block determining unit 602 determines the representative block 1 that is closest to the position of the minimum block C, and determines the representative blocks 2 through 5 that are close to the representative block 1.

A vector selecting unit 603 of the temporally-adjacent vector predictor generating unit 600 determines, in sequence, whether the prediction mode of each of the determined representative blocks 1 through 5 is the intra prediction mode. If one of the representative blocks 1 through 5, whose prediction mode is not the intra prediction mode, includes a motion vector, the vector selecting unit 603 selects the motion vector. The vector selecting unit 603 outputs motion vector information including the selected motion vector to the scaling unit 304.

Components other than the temporally-adjacent vector predictor generating unit 600 of the video decoding apparatus of the third embodiment are substantially the same as those of the second embodiment, and therefore their descriptions are omitted here.

### <Operations>

Exemplary operations of the video decoding apparatus of the third embodiment are described below. The decoding process performed by the video decoding apparatus of the third embodiment is substantially the same as that illustrated in FIG. 13, and therefore its descriptions are omitted here.

The temporally-adjacent vector predictor generating unit 600 of the third embodiment performs a block determining process and a vector selecting process. In the block determining process, the representative block 1 that is closest to the position of the minimum block C is determined, and then the representative blocks 2 through 5 that are close to the representative block 1 are determined.

In the vector selecting process, the representative blocks 1 through 5 are searched in this order to find a motion vector for inter prediction, and the found motion vector is selected.

Thus, similarly to the second embodiment, the third embodiment makes it possible to improve the prediction accuracy of a temporal vector predictor candidate even if the amount of motion vector information is reduced.

### Fourth Embodiment

Next, a video coding apparatus 700 according to a fourth embodiment is described. The video coding apparatus 700 of the fourth embodiment may include a temporally-adjacent vector predictor generating unit of any one of the first through third embodiments.

### <Configuration>

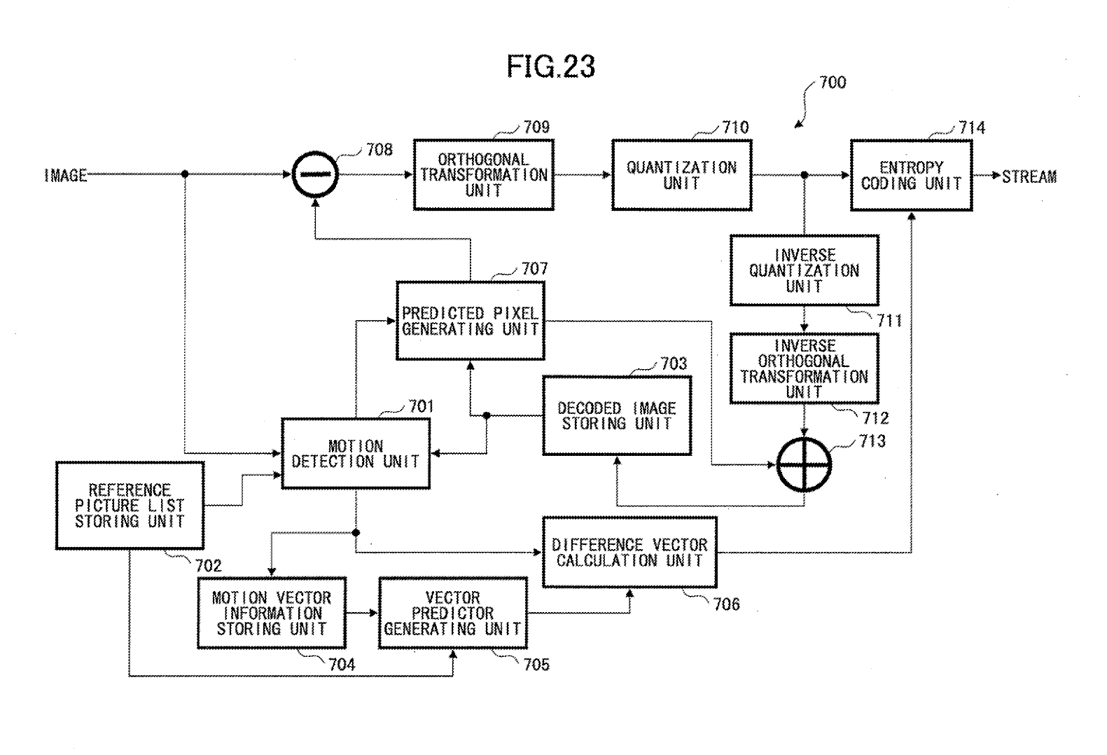

FIG. 23 is a block diagram illustrating an exemplary configuration of the video coding apparatus 700 according to the fourth embodiment. As illustrated in FIG. 23, the video coding apparatus 700 may include a motion detection unit 701, a reference picture list storing unit 702, a decoded image storing unit 703, a motion vector information storing unit 704, a vector predictor generating unit 705, and a difference vector calculation unit 706.

The video coding apparatus 700 may also include a predicted pixel generating unit 707, a prediction error generating unit 708, an orthogonal transformation unit 709, a quantization unit 710, an inverse quantization unit 711, an inverse orthogonal transformation unit 712, a decoded pixel generating unit 713, and an entropy coding unit 714.

The motion detection unit 701 obtains an original image, obtains the storage location of a reference picture from the reference picture list storing unit 702, and obtains pixel data of the reference picture from the decoded image storing unit 703. The motion detection unit 701 detects reference indexes and motion vectors of L0 and L1. Then, the motion detection unit 701 outputs region location information of reference pictures that the detected motion vectors refer to, to the predicted pixel generating unit 707.

The reference picture list storing unit 702 stores picture information including storage locations of reference pictures and POCs of reference pictures that a target block can refer to.

The decoded image storing unit 703 stores pictures that have been previously encoded and locally decoded in the video coding apparatus 700 as reference pictures used for motion compensation.

The motion vector information storing unit 704 stores motion vector information including reference indexes of L0 and L1 and motion vectors detected by the motion detection unit 701. In other words, the motion vector information storing unit 704 stores motion vectors of blocks in previously-encoded pictures. For example, the motion vector information storing unit 704 stores motion vector information including motion vectors of blocks that are temporally and spatially adjacent to a target block and reference picture identifiers indicating pictures that the motion vectors refer to.

The vector predictor generating unit 705 generates vector predictor candidate lists for L0 and L1. Vector predictor candidates may be generated as described in the first through third embodiments.

The difference vector calculation unit 706 obtains the motion vectors of L0 and L1 from the motion vector detection unit 701, obtains the vector predictor candidate lists of L0 and L1 from the vector predictor generating unit 705, and calculates difference vectors.

For example, the difference vector calculation unit 706 selects vector predictors that are closest to the motion vectors of L0 and L1 (L0 and L1 motion vectors) from the vector predictor candidate lists, and thereby determines vector predictors (L0 and L1 vector predictors) and predictor candidate indexes for L0 and L1.

Then, the difference vector calculation unit 706 subtracts the L0 vector predictor from the L0 motion vector to generate an L0 difference vector, and subtracts the L1 vector predictor from the L1 motion vector to generate an L1 difference vector.

The predicted pixel generating unit 707 obtains reference pixels from the decoded image storing unit 703 based on the region location information of reference pictures input from the motion detection unit 701, and generates a predicted pixel signal.

The prediction error generating unit 708 obtains the original image and the predicted pixel signal, and calculates a difference between the original image and the predicted pixel signal to generate a prediction error signal.

The orthogonal transformation unit 709 performs orthogonal transformation such as discrete cosine transformation on the prediction error signal, and outputs an orthogonal transformation coefficient to the quantization unit 710. The quantization unit 710 quantizes the orthogonal transformation coefficient.

The inverse quantization unit 711 performs inverse quantization on the quantized orthogonal transformation coefficient. The inverse orthogonal transformation unit 712 performs inverse orthogonal transformation on the inversely-quantized coefficient.

The decoded pixel generating unit 713 adds the prediction error signal and the predicted pixel signal to generate decoded pixels. A decoded image including the generated decoded pixels is stored in the decoded image storing unit 703.

The entropy coding unit 714 performs entropy coding on the reference indexes, the difference vectors, and the predictor candidate indexes of L0 and L1 and the quantized orthogonal transformation coefficient obtained from the difference vector calculation unit 706 and the quantization unit 710. Then, the entropy coding unit 714 outputs the entropy-coded data as a stream.

### <Operations>

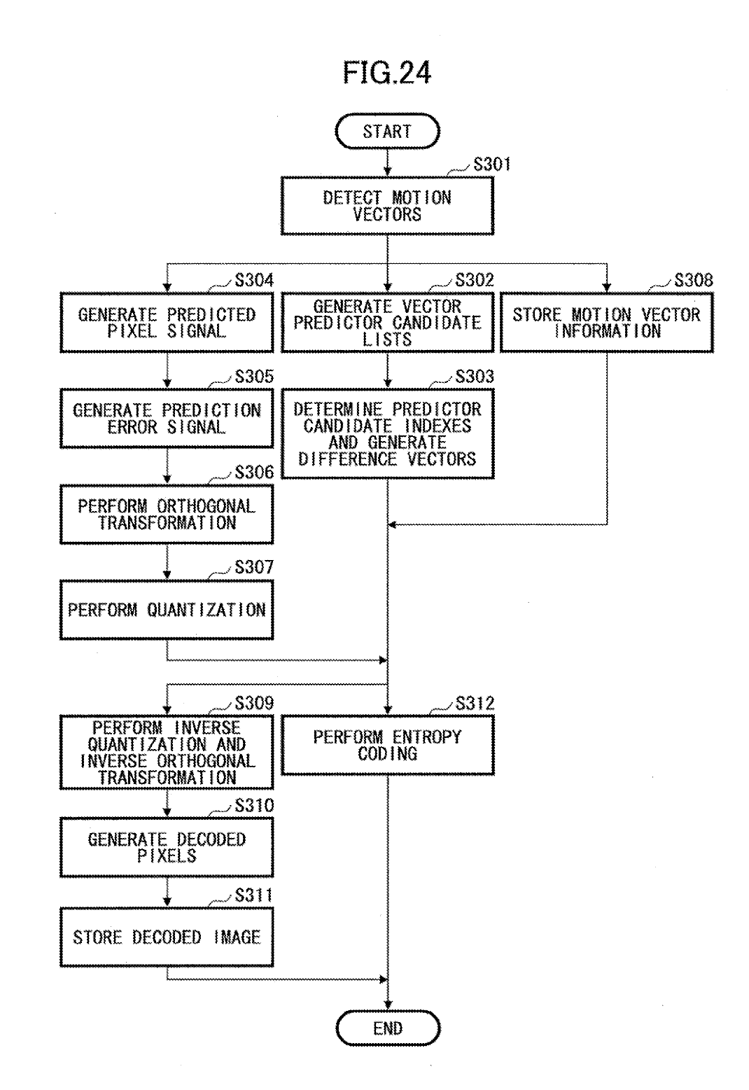

Next, exemplary operations of the video coding apparatus 700 of the fourth embodiment are described. FIG. 24 is a flowchart illustrating an exemplary process performed by the video coding apparatus 700. In the process of FIG. 24, one block, which is a unit of processing, is encoded.

In step S301, the motion vector detection unit 701 obtains an original image and pixel data of a reference picture, and detects reference indexes and motion vectors of L0 and L1.

In step S302, the vector predictor generating unit 705 generates vector predictor candidate lists for L0 and L1. In this step, the vector predictor generating unit 705 obtains a temporal vector predictor candidate with high accuracy in a manner similar to any one of the first through third embodiments.

In step S303, the difference vector calculation unit 706 selects vector predictors that are closest to the motion vectors of L0 and L1 (L0 and L1 motion vectors) from the vector predictor candidate lists, and thereby determines vector predictors (L0 and L1 vector predictors) and predictor candidate indexes for L0 and L1.

Then, the difference vector calculation unit 306 subtracts the L0 vector predictor from the L0 motion vector to generate an L0 difference vector, and subtracts the L1 vector predictor from the L1 motion vector to generate an L1 difference vector.

In step S304, the predicted pixel generating unit 707 obtains reference pixels from the decoded image storing unit 703 based on the region location information of reference pictures input from the motion detection unit 701, and generates a predicted pixel signal.

In step S305, the prediction error generating unit 708 receives the original image and the predicted pixel signal, and calculates a difference between the original image and the predicted pixel signal to generate a prediction error signal.

In step S306, the orthogonal transformation unit 709 performs orthogonal transformation on the prediction error signal to generate an orthogonal transformation coefficient.

In step S307, the quantization unit 710 quantizes the orthogonal transformation coefficient.

In step S308, the motion vector information storing unit 704 stores motion vector information including the reference indexes and the motion vectors of L0 and L1 output from the motion detection unit 701. The stored information is used in the subsequent block coding process.

Steps S302 and S303, steps S304 through S307, and step S308 are not necessarily performed in the order described above, and may be performed in parallel.

In step S309, the inverse quantization unit 711 performs inverse quantization on the quantized orthogonal transformation coefficient. Also in this step, the inverse orthogonal transformation unit 712 generates a prediction error signal by performing inverse orthogonal transformation on the inversely-quantized orthogonal transformation coefficient.

In step S310, the decoded pixel generating unit 713 adds the prediction error signal and the predicted pixel signal to generate decoded pixels.

In step S311, the decoded image storing unit 703 stores a decoded image including the decoded pixels. The decoded image is used in the subsequent block coding process.

In step S312, the entropy coding unit 714 performs entropy coding on the reference indexes, the difference vectors, and the predictor candidate indexes of L0 and L1 and the quantized orthogonal transformation coefficient, and outputs the entropy-coded data as a stream.

Thus, the fourth embodiment makes it possible to improve the accuracy of a temporal vector predictor and to provide a video coding apparatus with improved coding efficiency. A vector predictor generating unit of any one of the first through third embodiments may be used for the vector predictor generating unit 705 of the video coding apparatus 700.

### Example

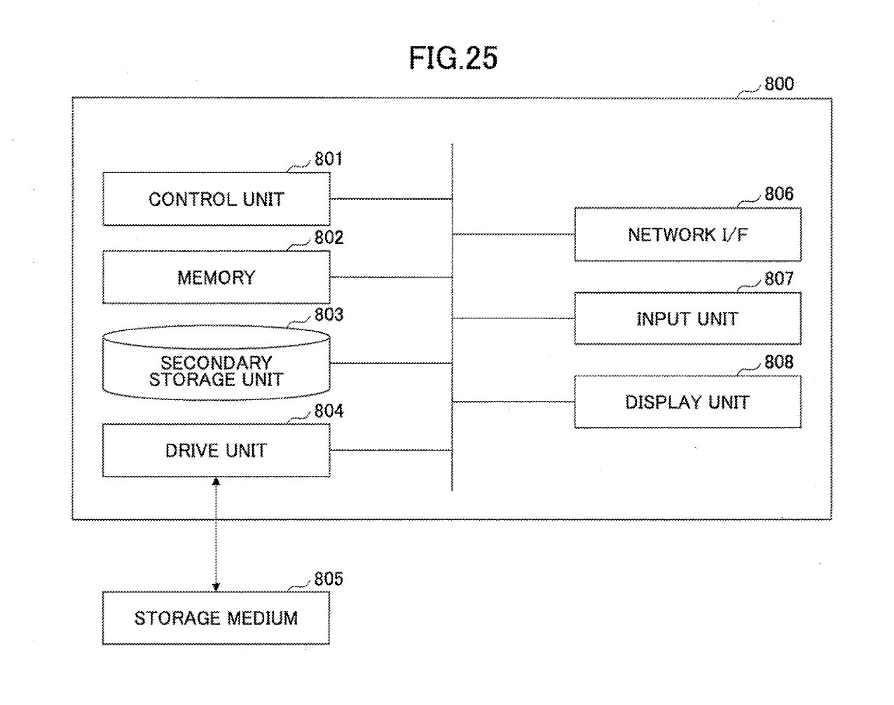

FIG. 25 is a drawing illustrating an exemplary configuration of an image processing apparatus 800. The image processing apparatus 800 is an exemplary implementation of a video decoding apparatus or a video coding apparatus of the above embodiments. As illustrated in FIG. 25, the image processing apparatus 800 may include a control unit 801, a memory 802, a secondary storage unit 803, a drive unit 804, a network interface (I/F) 806, an input unit 807, and a display unit 808. These components are connected to each other via a bus to enable transmission and reception of data.

The control unit 801 is a central processing unit (CPU) that controls other components of the image processing apparatus 800 and performs calculations and data processing. For example, the control unit 801 executes programs stored in the memory 802 and the secondary storage unit 803, processes data received from the input unit 807 and the secondary storage unit 803, and outputs the processed data to the display unit 808 and the secondary storage unit 803.

The memory 802 may be implemented, for example, by a read-only memory (ROM) or a random access memory (RAM), and retains or temporarily stores data and programs such as basic software (operating system (OS)) and application software to be executed by the control unit 801.

The secondary storage unit 803 may be implemented by a hard disk drive (HDD), and stores, for example, data related to application software.

The drive unit 804 reads programs from a storage medium 805 and installs the programs in the secondary storage unit 803.

The storage medium 805 stores programs. The programs stored in the storage medium 805 are installed in the image processing apparatus 800 via the drive unit 804. The installed programs can be executed by the image processing apparatus 800.

The network I/F 806 allows the image processing apparatus 800 to communicate with other devices connected via a network, such as a local area network (LAN) or a wide area network (WAN), implemented by wired and/or wireless data communication channels.

The input unit 807 may include a keyboard including cursor keys, numeric keys, and function keys, and a mouse or a trackpad for selecting an item on a screen displayed on the display unit 808. Thus, the input unit 807 is a user interface that allows the user to input, for example, instructions and data to the control unit 801.

The display unit 808 includes, for example, a liquid crystal display (LCD) and displays data received from the control unit 801. The display unit 808 may be provided outside of the image processing apparatus 800. In this case, the image processing apparatus 800 may include a display control unit.

The video coding and decoding methods (or processes) described in the above embodiments may be implemented by programs that are executed by a computer. Such programs may be downloaded from a server and installed in a computer.

Alternatively, programs for implementing the video coding and decoding methods (or processes) described in the above embodiments may be stored in a non-transitory, computer-readable storage medium such as the storage medium 805, and may be read from the storage medium into a computer or a portable device.

For example, storage media such as a compact disk read-only memory (CD-ROM), a flexible disk, and a magneto-optical disk that record information optically, electrically, or magnetically, and semiconductor memories such as a ROM and a flash memory that record information electrically may be used as the storage medium 805. Further, the video coding and decoding methods (or processes) described in the above embodiments may be implemented by one or more integrated circuits.

All examples and conditional language recited herein are intended for pedagogical purposes to aid the reader in understanding the invention and the concepts contributed by the inventors to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A video decoding apparatus, comprising:
a motion vector information storing unit configured to store motion vectors of blocks in previously-decoded pictures; and
a temporally-adjacent vector predictor generating unit including
a block determining unit configured to determine multiple blocks in a picture that is temporally adjacent to a picture including a target block to be processed, the determined blocks including a block that is closest to first coordinates in the target block,
a vector selecting unit configured to obtain motion vectors of the determined blocks from the motion vector information storing unit and select at least one motion vector from the obtained motion vectors, and
a generating unit configured to generate a vector predictor candidate, which is used for a decoding process of the target block, based on the selected motion vector.

2. The video decoding apparatus as claimed in claim 1, wherein the vector selecting unit includes
a scaling unit configured to scale the motion vectors of the determined blocks such that the scaled motion vectors refer to the picture including the target block;
a distance calculation unit configured to calculate sets of third coordinates by adding the scaled motion vectors and second coordinates in the respective determined blocks, and to calculate distances between the first coordinates and the sets of third coordinates; and
a comparison unit configured to select at least one motion vector from the motion vectors of the determined blocks based on the calculated distances.

3. The video decoding apparatus as claimed in claim 1, wherein
the motion vector information storing unit includes
a motion vector reducing unit configured to determine a representative block in each predetermined range of blocks and cause the motion vector information storing unit to store the motion vector of the representative block for the predetermined range of blocks; and
the block determining unit is configured to determine the multiple blocks from representative blocks determined by the motion vector reducing unit.

4. The video decoding apparatus as claimed in claim 1, wherein the first coordinates are in a lower-right region of the target block, the lower-right region including a center of the target block.

5. The video decoding apparatus as claimed in claim 2, wherein the comparison unit is configured to select one of the motion vectors of the determined blocks which corresponds to a smallest one of the calculated distances.

6. The video decoding apparatus as claimed in claim 2, wherein the comparison unit is configured to select one of the motion vectors of the determined blocks which corresponds to one of the calculated distances that is less than a threshold.

7. A video coding apparatus, comprising:
a motion vector information storing unit configured to store motion vectors of blocks in previously-encoded pictures; and
a temporally-adjacent vector predictor generating unit including
a block determining unit configured to determine multiple blocks in a picture that is temporally adjacent to a picture including a target block to be processed, the determined blocks including a block that is closest to first coordinates in the target block,
a vector selecting unit configured to obtain motion vectors of the determined blocks from the motion vector information storing unit and select at least one motion vector from the obtained motion vectors, and
a generating unit configured to generate a vector predictor candidate, which is used for an encoding process of the target block, based on the selected motion vector.

8. A method performed by a video decoding apparatus, the method comprising:
determining multiple blocks in a picture that is temporally adjacent to a picture including a target block to be processed, the determined blocks including a block that is closest to first coordinates in the target block,
obtaining motion vectors of the determined blocks from a motion vector information storing unit storing motion vectors of blocks in previously-decoded pictures;
selecting at least one motion vector from the obtained motion vectors; and
generating a vector predictor candidate, which is used for a decoding process of the target block, based on the selected motion vector.

9. A method performed by a video coding apparatus, the method comprising:
determining multiple blocks in a picture that is temporally adjacent to a picture including a target block to be processed, the determined blocks including a block that is closest to first coordinates in the target block,
obtaining motion vectors of the determined blocks from a motion vector information storing unit storing motion vectors of blocks in previously-encoded pictures;
selecting at least one motion vector from the obtained motion vectors; and
generating a vector predictor candidate, which is used for an encoding process of the target block, based on the selected motion vector.

10. A non-transitory computer-readable storage medium storing program code for causing a video decoding apparatus to perform the method of claim 8.

11. A non-transitory computer-readable storage medium storing program code for causing a video coding apparatus to perform the method of claim 9.
